(19) United States
(12) Patent Application Publication
(10) Pub. No.: US 2026/0330948 A1
(43) Pub. Date: Oct. 22, 2026

(54) SYSTEM

(71) Applicant: SoftBank Group Corp., Tokyo (JP)

(72) Inventor: Akari KIDO, Tokyo (JP)

(73) Assignee: SoftBank Group Corp., Tokyo (JP)

(21) Appl. No.: 19/649,128

(22) Filed: Apr. 16, 2026

(30) Foreign Application Priority Data
Apr. 22, 2025 (JP) 2025-070676

(51) Int. Cl. G08B 21/02; G08B 21/04

(52) U.S. Cl. CPC G08B 21/0225; G08B 21/0211; G08B 21/0288; G08B 21/043

(57) ABSTRACT

The present invention relates to a system in which, in order to watch over the safety and health of kindergarteners in a childcare facility on a 24-hour basis, activity statuses and vital data are collected in real time from a plurality of image acquisition units installed in a facility and a biological information acquisition unit worn by a kindergartener, a generative AI processing unit integrally analyzes these pieces of information to determine an abnormality with high accuracy, and when an abnormality occurs, an optimal notification text and response instruction are automatically generated and transmitted to a medical institution, a guardian, a childcare worker terminal, and the like via a communication control unit and a notification unit, thereby simultaneously realizing a reduction in the burden on childcare workers and an improvement in the safety of kindergarteners, and enabling advanced operation of a childcare site independent of human resources.

### CROSS-REFERENCE TO RELATED APPLICATION

The present application claims priority to and incorporates by reference the entire contents of Japanese Patent Application No. 2025-070676 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is to comprehensively and efficiently solve a plurality of social and on-site problems such as a shortage of personnel and long working hours of childcare workers, occurrence of human errors, an insufficient monitoring system at night and on holidays, difficulty in early detection and prompt response when a sudden change in physical condition of a kindergartener or an accident occurs, a delay in real-time information sharing with guardians, limits of conventional health management by visual observation and manual work, difficulty in appropriate individual response to a change in a state of each kindergartener, and an increase in mental and physical burden on childcare workers, despite the need to reliably watch over the safety and health of kindergarteners in a childcare facility on a 24-hour basis, and specifically, an object thereof is to automatically collect and analyze activity statuses and biological information of kindergarteners in a multifaceted manner and in real time, and when an abnormality occurs, automatically notify related parties such as a medical institution and guardians of necessary information immediately using generative AI, thereby achieving both a reduction in the burden on childcare workers and the safety and health maintenance of kindergarteners, and dramatically improving the quality and efficiency of the entire childcare site.

### SUMMARY OF THE INVENTION

A means for solving the problem according to the present invention is configured such that a plurality of image acquisition units installed in a facility acquire activity statuses of a kindergartener such as walking, eating and drinking, excretion, and sleeping in chronological order, a biological information acquisition unit worn by the kindergartener acquires biological information such as a heart rate, a body temperature, a blood oxygen concentration, an activity amount, and position information in real time, a generative AI processing unit integrally and automatically analyzes these pieces of information to constantly monitor a state of each kindergartener, and when an abnormality is detected, a communication control unit automatically activates an AI application to perform necessary information transmission via a notification unit configured to transmit a notification including information such as an abnormality content, an occurrence time, a current position, latest vital data, and an activity history of the kindergartener to a medical institution or an emergency contact family member, thereby ensuring the safety and health of the kindergartener on a 24-hour basis without depending on human resources, significantly reducing the burden on childcare workers, and enabling a prompt and accurate response when an abnormality occurs.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

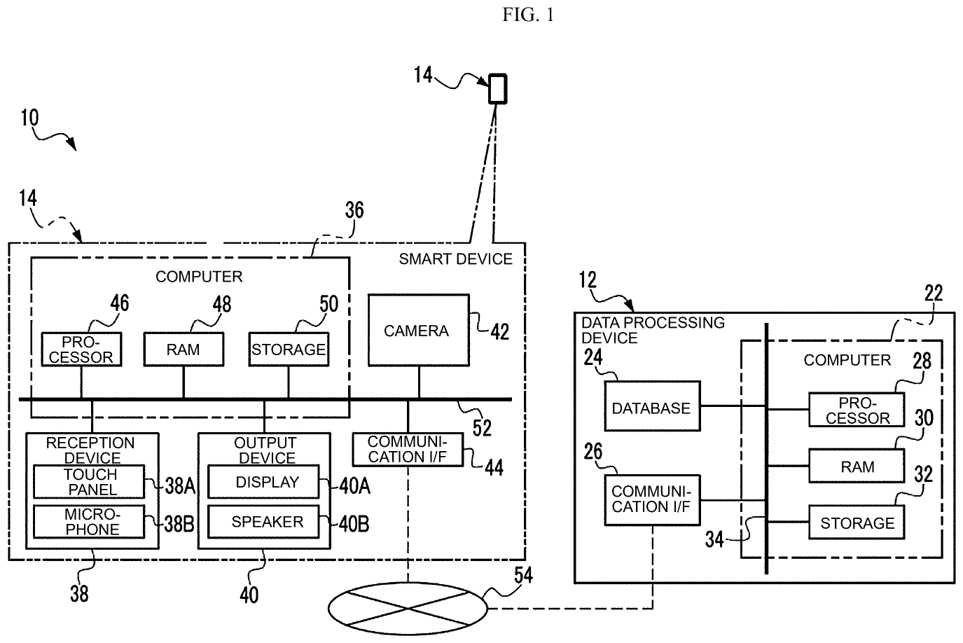

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

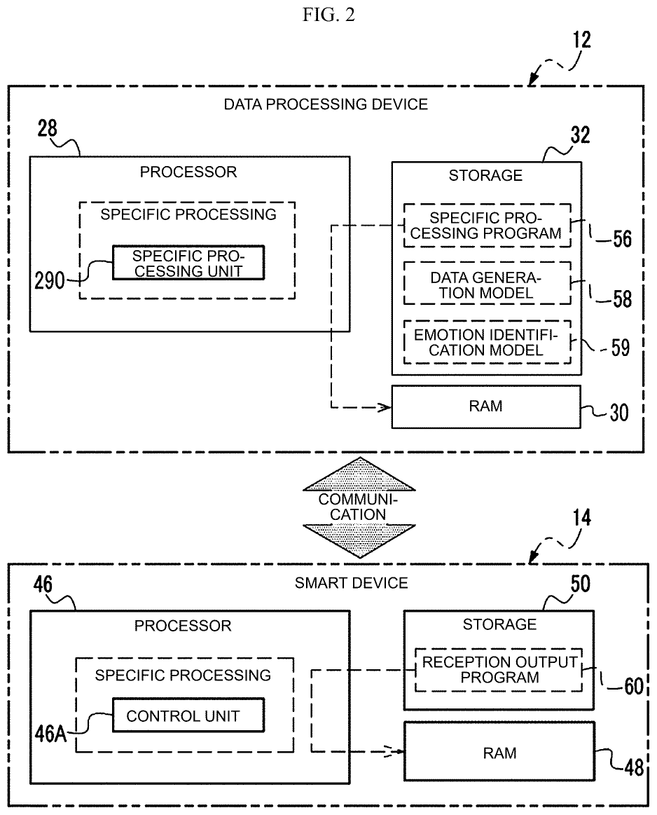

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### (Example 1)

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

Embodiments of the present invention will be described more specifically and in detail. The present invention is a system for watching over the safety and health of kindergarteners in a childcare facility on a 24-hour basis, and is composed of a server and a terminal. The functional division of each part is as follows. Specifically, the present system adopts a distributed processing architecture composed of a plurality of computing nodes. The present system connects the terminal, which is an edge device, and the server arranged in a cloud environment via a network. The present system efficiently transfers a huge amount of sensor data acquired on the terminal side to the server side. The present system arranges a parallel computing cluster using a GPU on the server side. The present server processes the received data at high speed. The present system introduces edge computing technology. The present terminal executes an initial filtering process on the acquired data. The present terminal transmits lightweight data from which noise has been removed to the server. The present system significantly reduces the consumption of a communication band by this configuration. The present system minimizes network delay. The present system realizes real-time data analysis. The present system is not merely an automation of human work. The present system optimally allocates computing resources of a computer. The present system improves the throughput of the entire system. The present system brings about an improvement in computer technology itself, which is the speeding up of data processing. The present system exhibits extremely high availability in a specific use case of a childcare facility. The present system includes a fault-tolerant design premised on 24-hour continuous operation. The present system continues processing even when a failure occurs in some nodes. The present system satisfies a mission-critical requirement of safety management of kindergarteners.

First, the image acquisition units are composed of a plurality of cameras and image sensors installed in various places in the facility. For example, cameras are installed in all places where movement and activities of kindergarteners are assumed, such as a corridor, a childcare room, a dining room, a toilet, a bedroom, a kindergarten yard, an entrance, stairs, a playroom, and a bus pickup/drop-off entrance. Thereby, all activity statuses such as walking, a fall, wandering, eating and drinking, excretion, sleeping, playing, going out, and returning home of the kindergartener can be acquired in chronological order without omission. The image acquisition units are installed on the terminal side, but the acquired image data is transmitted to the server in real time. For example, when a kindergartener falls while walking in a corridor, the camera immediately captures the motion and transmits the image data to the server. Specifically, the present image acquisition unit includes a composite sensor module combining an RGB sensor that captures visible light, an infrared sensor capable of photographing even in a dark place, and a depth sensor that measures a distance to an object. The present image acquisition unit captures a moving image at a high frame rate of 60 frames per second. The present image acquisition unit converts the acquired analog image signal into digital data. The present image acquisition unit executes a resizing process and a pixel value normalization process on the digitized image data. The present image acquisition unit converts the processed data into a multidimensional image tensor. The present image acquisition unit executes a moving object detection algorithm using a background subtraction method or an optical flow by an internal microprocessor. The present image acquisition unit performs a trigger process of transmitting the image data to the server only when a movement is detected in a screen. The present system suppresses unnecessary data transfer by this dynamic transmission control. The present system prevents depletion of a network band. The present system significantly reduces a storage consumption amount on the server side. The present system exhibits a technical effect of improving the efficiency of data management. The present system is applied to various use cases such as monitoring of a sleeping state in a bedroom at night and watching over without a blind spot in an outdoor kindergarten yard. The present system executes an unconventional procedure premised on image feature extraction in a high-dimensional space. The present system fundamentally transforms conventional visual monitoring work.

Next, the biological information acquisition unit is composed of a wearable terminal worn by the kindergartener. For example, an optimal terminal can be selected according to the age, activity characteristics, allergies, and skin condition of the kindergartener, such as a wristband-type terminal, a clothing-integrated sensor, a shoe-built-in sensor, a neck-hanging-type terminal, and an ear-hanging-type terminal. These terminals acquire a wide variety of biological information in real time, such as a heart rate, a body temperature, a blood oxygen concentration, a respiratory rate, an activity amount, an acceleration, position information, a sweating amount, a skin temperature, a skin potential, a body movement during sleep, fall detection, an immobility time, a number of steps, a posture, and a voice (such as a cough or a crying voice). For example, when the breathing of the kindergartener becomes shallow during a nap, the terminal detects a change in the respiratory rate or the body movement, and transmits data to the server. The terminal transmits the data to the server or a relay terminal using Bluetooth, a wireless LAN, near field communication, a mobile phone line, or the like. For example, a plurality of gateway terminals for relay are installed in the facility so that data is reliably aggregated wherever the kindergartener is. Specifically, the present biological information acquisition unit adopts a multi-sensor fusion technology integrating a plurality of small sensors. The present terminal converts a minute analog voltage signal output from each sensor into a highly accurate digital signal by a built-in AD converter. The present terminal samples data at an optimal frequency for each biological indicator based on the sampling theorem. The present terminal applies a Kalman filter or a low-pass filter to the acquired data. The present terminal effectively removes an artifact or environmental noise accompanying a body movement. The present terminal temporarily stores the data after noise removal in a memory as a multidimensional time-series numerical vector together with a time stamp. The present terminal includes a communication module configuring a mesh network topology. The present terminal dynamically selects a gateway terminal having the highest radio wave intensity and transmits the data. The present system prevents loss of a data packet by this redundant communication path. The present system automatically reconstructs a path even in the event of a communication failure. The present system brings about a technical effect of ensuring the continuity and completeness of data. The present system dramatically extends a battery life by adopting a low power consumption microcomputer and intermittent operation control. The present system eliminates the need for frequent charging work. The present system realizes advanced use cases such as continuous tracking of position information during an outdoor activity such as an excursion and detection of a minute change in skin temperature of an allergic child.

A generative AI processing unit is provided on the server side. This generative AI processing unit integrally analyzes the image data from the image acquisition units and the vital data from the biological information acquisition unit. For example, using image recognition AI, a walking pattern, a falling motion, a chewing or swallowing motion during a meal, a posture or motion during excretion, a body movement or breathing pattern during sleep, an abnormal behavior during play, wandering or deviation outside the facility, a fall risk on stairs, and the like of the kindergartener are determined with high accuracy. Furthermore, the generative AI learns a past activity history and vital data accumulated for each kindergartener, and automatically generates an individual normal range. For example, when a certain kindergartener has a higher heart rate than usual but has no health problem, the generative AI can automatically set a normal range optimized for the kindergartener to prevent an excessive alert. Conversely, a minute change can also be individually detected, such as when a normally energetic kindergartener suddenly stands still or when a body temperature rises slightly more than usual. Specifically, the present generative AI processing unit includes a multimodal model combining a convolutional neural network that extracts an image feature and a transformer architecture that processes time-series data. The present processing unit receives a 3-channel RGB image tensor with a resolution of 224 pixels square as input data. The present processing unit receives a 60-dimensional numerical vector indicating a heart rate transition for the past 60 seconds as input data. The present processing unit receives a 128-dimensional time-series array obtained from a 3-axis acceleration sensor as input data. The present model maps these input data to a common high-dimensional latent space. The present model calculates a correlation between respective modalities using a self-attention mechanism. The present model generates a probability distribution indicating a current behavioral state of the kindergartener as output data. The present model outputs a numerical value of a probability of 0.85 of being in a walking state as a specific example of the output data. The present model outputs a numerical value of a probability of 0.92 of being in a falling state. The present model outputs a numerical value of a probability of 0.99 of being in a sleeping state. The present processing unit transmits this output probability distribution to a subsequent abnormality determination module. The subsequent abnormality determination module compares the received probability value with a preset dynamic threshold value. The subsequent module executes a branch process of alert issuance when the probability value exceeds the threshold value. The present system continuously updates a baseline model for each kindergartener using self-supervised learning. The present system realizes highly accurate abnormality detection absorbing individual differences. The present system exhibits a technical effect of dramatically reducing a false alarm rate. The present system is applied to life-threatening use cases such as early discovery of a choking risk during a meal and sign detection of sleep apnea syndrome.

The generative AI also plays a role in an abnormality detection algorithm. For example, when a heart rate rapidly increases, when a body temperature exceeds 38 degrees, when a falling motion is detected, when not returning from a toilet for a long time, when respiratory arrest is suspected during sleep, when a violent crying voice or screaming voice is detected during play, when deviation outside the facility is detected, or when a plurality of kindergarteners simultaneously show an abnormal behavior, a plurality of abnormal patterns are analyzed in real time to detect an abnormality. Furthermore, the generative AI automatically determines an urgency level of the abnormality by combining a plurality of data sources. For example, if there is a rapid drop in the heart rate simultaneously with fall detection, it is determined as a serious accident, and immediate reporting to a medical institution is instructed. Conversely, in a case of a minor fever or temporary immobility, a notification destination and a notification content are automatically optimized, such as only notifying a childcare worker. Specifically, the present generative AI executes an unsupervised abnormality detection model based on reconstruction error calculation using an autoencoder. The present model receives a multidimensional vector of normalized vital data as input data. The present model receives a skeletal coordinate tensor of posture estimation extracted from an image as input data. The present model receives a mel-frequency cepstral coefficient array of an audio signal as input data. The present model compresses these input data into a low-dimensional latent variable and then restores them to the original dimension. The present model calculates a mean square error between the input data and the restored data. The present model calculates an abnormality score taking a continuous value in a range of 0.0 to 1.0 as output data. The present model outputs a heart rate abnormality score of 0.88 as a specific example of the output data. The present model outputs a fall abnormality score of 0.95. The present model outputs a voice abnormality score of 0.72. The present processing unit inputs the calculated plurality of abnormality scores to a subsequent urgency level determination module. The subsequent urgency level determination module outputs an urgency level as an integer value from 1 to 5 from a combination of the scores using a random forest algorithm. The subsequent module executes a routing process of determining a notification destination according to the urgency level. The present system hybridly combines rule-based threshold determination and pattern recognition by machine learning. The present system provides a robust detection capability even for an unknown abnormal pattern. The present system brings about a technical effect of performing triage at a speed and accuracy exceeding human cognitive limits. The present system is applied to use cases requiring complex situation judgment, such as early detection of a mass outbreak of an infectious disease and grasping of a panic state at the time of a suspicious person intrusion.

When an abnormality is detected, the communication control unit on the server side automatically activates an AI application to perform information transmission to a medical institution or an emergency contact family member. For example, a name, an age, a current position, an abnormality content, an occurrence time, latest vital data, an activity history, image data, a past health condition, medical history information, allergy information, medication information, a name of a responding childcare worker, a response start time, and the like of the kindergartener are transmitted to the medical institution as an automatically generated report. The family member is notified of the occurrence of the abnormality in real time by a desired means such as a smartphone notification, an email, a voice call, an SNS notification, or an automatic response by a chatbot. A notification content is also automatically generated by the generative AI, and an optimal text according to the situation is created, such as, for example, “The kindergartener fell and temporarily lost consciousness. A childcare worker is currently responding, and a medical institution has already been contacted.”, “The body temperature of the kindergartener has risen to 38.2 degrees. The kindergartener is currently resting, and a childcare worker is observing the progress.”, or “The kindergartener may have gone outside the facility. The current position is near the main gate. A childcare worker is heading to the site.” Specifically, the present communication control unit drives a natural language generation engine using a large language model. The present engine receives structured JSON-format abnormality data output from an abnormality determination unit as input data. The present engine receives an attribute metadata vector of the kindergartener extracted from a database as input data. The present engine receives a status code array indicating a current response status as input data. The present engine integrates these input data as context information using prompt engineering technology. The present engine generates a text character string including specialized medical terms for a medical institution as output data. The present engine generates a text character string using plain expressions for a guardian as output data. The present engine outputs a summary report character string for emergency transport as a specific example of the output data. The present engine outputs a short alert message character string for SNS notification. The present engine outputs a reading script character string for voice synthesis. The present processing unit passes the generated text data to a subsequent API linkage module. The subsequent API linkage module transmits an HTTP request to an external messaging service or an electronic medical record system. The present system executes an automatic conversion process into an optimal format tailored to an information recipient. The present system eliminates a delay in information transmission in an emergency. The present system exhibits a technical effect of preventing a transmission error and improving the accuracy of communication. The present system is applied to use cases satisfying various accessibility requirements, such as a notification to a foreign guardian requiring multilingual support and a visual notification to a guardian with a hearing impairment.

A management terminal used by a childcare worker or an administrator is provided on the terminal side, and is equipped with a function of receiving a notification from the server, a function of monitoring a state of a kindergartener in real time, a function of instructing an additional response when an abnormality occurs, a browsing function of vital data and an activity history for each kindergartener, a display function of a basis for abnormality determination by the generative AI and a recommended response measure, a management function of a contact history to a guardian, a management function of a cooperation history with a medical institution, an automatic generation function of a health record of a kindergartener, an information sharing function among childcare workers, a visualization function of a behavior pattern and a health tendency of a kindergartener, and the like. For example, a childcare worker carries a tablet terminal or a smartphone terminal, and can immediately confirm vital data and an activity history for each kindergartener. In addition, since the basis for abnormality determination by the generative AI and the recommended response measure are also displayed on the terminal, the childcare worker can respond quickly and accurately. For example, a specific response instruction is displayed, such as “The heart rate of kindergartener A has increased by 20% from normal. Hydration and rest are recommended.” Specifically, the present management terminal executes a dynamic graphical user interface based on a single-page application architecture. The present terminal establishes a bidirectional real-time communication session with the server using a WebSocket protocol. The present terminal implements explainable AI technology. The present terminal receives an abnormality score and an image tensor transmitted from the server as input data. The present terminal receives an attention weight matrix as input data. The present terminal receives a list array of recommended actions as input data. The present terminal generates a heat map image highlighting an abnormal part in an image as output data. The present terminal draws a time-series line graph indicating a fluctuation of vital data as output data. The present terminal outputs an overlay image in which a fall location is surrounded by a red frame as a specific example of the output data. The present terminal outputs a graph object highlighting a rapid rise point of a heart rate. The present terminal outputs a checklist UI of prioritized response tasks. The present terminal renders these output results in a designated layout area on a display. As a subsequent process, the present terminal detects an input event of response completion selected by the childcare worker on a touch panel. The present terminal feedback-transmits the event data to the server. The present system continuously improves the accuracy of a recommended action from the feedback of the childcare worker using reinforcement learning. The present system optimizes memory management and drawing processing of the terminal. The present system brings about a technical effect of speeding up an operation response and suppressing battery consumption. The present system is applied to use cases that dramatically improve on-site operational efficiency, such as information sharing during distributed childcare in a vast kindergarten yard and real-time business navigation for a new childcare worker.

Furthermore, the generative AI is also utilized for operation optimization of the entire facility. For example, it is possible to analyze an activity pattern and a health condition tendency of a kindergartener, and automatically generate a proposal for optimizing a shift and an arrangement of childcare workers. It is also possible to learn past abnormality occurrence cases and propose future risk prediction and preventive measures. For example, when fall accidents occur frequently in a specific time zone or place, the information can be notified to a childcare worker or an administrator to prompt caution and environmental improvement in advance. Furthermore, the generative AI can automatically update a monitoring standard and a notification content according to a change in growth or health condition of a kindergartener. For example, when a reference heart rate or an activity amount changes with growth, the AI automatically sets a new standard and notifies a childcare worker or a family member. Specifically, the present generative AI executes a time-series prediction model using a long short-term memory network. The present model receives a time-series array of position information coordinates of kindergarteners for the past several months as input data. The present model receives a time stamp vector of an incident occurrence date and time as input data. The present model receives a two-dimensional matrix indicating a work shift table of childcare workers as input data. The present model calculates a spatial and temporal risk bias using a clustering algorithm. The present model outputs a prediction score of an accident occurrence probability in each time zone of the next week as output data. The present model outputs an integer value array indicating an optimal arrangement number of childcare workers as output data. The present model outputs a fall risk score of 0.75 in a kindergarten yard at 2:00 PM as a specific example of the output data. The present model outputs a numerical value of 3 monitoring staff members required for a playroom at 10:00 AM. The present model outputs a parameter of an updated normal upper limit value of a heart rate of 120 bpm. The present processing unit transmits the output prediction data to a subsequent dashboard generation module. The subsequent dashboard generation module dynamically draws a risk map based on the prediction data and distributes it to an administrator terminal. The present system dynamically updates a weight parameter of the model from daily new data using an online learning method. The present system enhances the followability of the model to an environmental change. The present system exhibits a technical effect of realizing optimization of facility operation and prevention of an accident while efficiently utilizing computing resources. The present system is applied to advanced use cases of data-driven facility management, such as shift adjustment during a seasonal infectious disease epidemic period and safety improvement by reviewing an arrangement of playground equipment.

In addition, in response to an inquiry from a guardian, the generative AI can automatically generate a detailed explanation or advice based on past data. For example, an explanation according to an individual situation is automatically generated to reduce anxiety of a guardian, such as “Kindergartener B had a body temperature exceeding 37.5 degrees three times in the past week, but returned to normal temperature in a short time in all cases.” or “Kindergartener C has recently had a decrease in body movement during a nap, but it is considered to be a change accompanying growth.” Specifically, the present generative AI executes a response generation system adopting a retrieval-augmented generation architecture. The present system receives a natural language question text character string transmitted from a guardian as input data. The present system receives an identifier code of a target kindergartener as input data. The present system converts the question text into a multidimensional query vector by a natural language processing model. The present system calculates a cosine similarity between the query vector and a past health record vector in a vector database. The present system extracts higher-ranked record data having a high similarity as context information. The present system combines the extracted context information and the question text and inputs them to a large language model. The present system generates a fact-based answer text character string as output data. The present system outputs JSON data for graph drawing indicating a transition of related vital data as output data. The present system outputs a 300-character text explaining a reason for a body temperature change as a specific example of the output data. The present system outputs a text explaining a change in a sleep pattern based on medical knowledge. The present system outputs a data point array indicating a body temperature transition for the past week. The present processing unit transmits the generated answer data to a subsequent chat interface control module. The subsequent module executes a rendering process of displaying the answer data in a speech balloon format on a smartphone application of the guardian. The present system dynamically combines an external knowledge base and internal time-series data. The present system strongly suppresses hallucination peculiar to AI. The present system brings about a technical effect of automating guardian response work and ensuring the accuracy of provided information. The present system is applied to use cases that strengthen engagement with a guardian, such as an immediate response to a health consultation with a low urgency level late at night or early in the morning, and automatic creation of a regular growth report.

As described above, in the embodiment of the present invention, the image acquisition units and the biological information acquisition unit are mainly realized on the terminal side, and the generative AI processing unit, the communication control unit, and the notification unit are mainly realized on the server side. However, the terminal side can also be provided with a part of data preprocessing and a simple abnormality detection function. For example, when a wearable terminal detects an acceleration equal to or greater than a certain level, an emergency signal is immediately transmitted to the server, so that the terminal side and the server side can cooperate to enhance the reliability and responsiveness of the entire system. Specifically, the present system constructs a federated learning environment in which edge AI and cloud AI operate in cooperation. The present terminal implements a lightweight inference model on an internal microcontroller. The present terminal monitors a raw acceleration data array acquired from a sensor in real time. The present terminal generates an interrupt process when a differential value of acceleration exceeds a preset hardware threshold value. The present terminal returns a main CPU from a sleep state by this interrupt process. The present terminal inserts a minimum data packet to which an emergency flag is added into a highest priority communication queue and transmits it to the server. Upon receiving the emergency packet, the present server immediately activates a high-load detailed analysis process. The present system reduces power consumption in normal times to the utmost limit by this hierarchical processing architecture. The present system shortens latency at the time of abnormality occurrence to a millisecond unit. The present system combines dynamic control of a communication band and a fault-tolerant design. The present system reliably delivers a critical alert even during network congestion. The present system exhibits a technical effect of dramatically improving the availability and response speed of the entire system. The present system is applied to use cases requiring extremely high real-time performance, such as instantaneous detection of a sudden collision accident during play and a zero-delay response to a rapid physical change such as an epileptic seizure. The present system provides an improvement in advanced distributed computing technology beyond mere data transmission and reception.

Furthermore, the utilization of the generative AI is not limited to mere abnormality detection and notification, but covers a wide variety of fields such as individual optimization for each kindergartener, automatic generation of a notification content, optimization of facility operation, provision of support information to a childcare worker, improvement of a sense of security for a family member, automatic generation of a health record, risk prediction, preventive measure proposal, inquiry response, and automatic creation of a growth record. For example, the generative AI can automatically update a monitoring standard and a notification content according to a change in growth and a health condition of the kindergartener. Furthermore, in response to an inquiry from a guardian, the generative AI can automatically generate a detailed explanation and advice based on past data. Specifically, the generative AI implements a multi-task learning model that simultaneously processes a plurality of tasks in a single network. The model receives a multidimensional vital time-series tensor of the kindergartener as input data. The model receives an embedding vector of a natural language text indicating a daily activity record as input data. The model extracts a general-purpose feature representation from these input data using a shared hidden layer. The model distributes the extracted feature to an output head dedicated to each task. The model outputs a regression score for abnormality detection as output data. The model outputs a summary text character string for a health record as output data. The model outputs a predicted value array of a growth curve as output data. The model outputs numerical data of a predicted height and weight of the next month as a specific example of the output data. The model outputs a childcare diary text of 200 characters summarizing daily activity contents. The model outputs a list array of a recommended play menu tailored to an individual developmental stage. The processing unit routes these diverse output data to respective subsequent application modules. The subsequent modules store the received data in a database and deploy the data on a user interface. The system introduces a continuous learning algorithm to learn a new pattern while preventing catastrophic forgetting of past knowledge. The system ensures functional expandability of the entire system while efficiently sharing computing resources. The system brings about technical effects of reducing memory usage and improving processing throughput. The system is applied to an advanced use case requiring long-term data accumulation and multifaceted analysis, such as long-term growth tracking until graduation from the kindergarten and early screening of an individual developmental disorder.

As described above, the embodiment of the present invention enables cooperative operation of the server and the terminal, multilayered utilization of the generative AI, compatibility of real-time performance and individual optimization, and flexible operation in line with the actual situation of a childcare site, and provides a new foundation for safety and health management of kindergarteners in a childcare facility. Specifically, the system adopts a microservice architecture in which each functional module is deployed as an independent container. The system dynamically scales out or scales in computing nodes according to an increase or decrease in traffic using a container orchestration tool. The system executes end-to-end encryption processing in all communication paths from the terminal to the server. The system strongly protects biological data and image data of the kindergartener, which are sensitive personal information. The system seamlessly integrates high-speed primary processing on the edge side and advanced secondary processing by a deep learning model on the cloud side. The system overcomes physical constraints of hardware by distributed processing technology of software. The system achieves a remarkable improvement in computer technology of maximizing analysis accuracy while minimizing data processing latency. The system functions not merely as a tool for operational efficiency improvement but as a data-driven advanced computing processing foundation. The system exhibits a technical effect of ensuring robustness and scalability of the entire system. The system provides an infrastructure that can be flexibly introduced regardless of scale, from a single small-scale nursery school to a large-scale nursery school network expanding nationwide. The system has expandability capable of executing addition of a new wearable device and an update to the latest AI algorithm in the future without stopping the system. The system strongly drives digital transformation in the childcare site from a technical aspect.

### (System Configuration)

The system according to the present embodiment comprises image acquisition units, a biological information acquisition unit, a data aggregation unit, a generative AI processing unit, an abnormality determination unit, a communication control unit, a notification unit, a management terminal unit, a record management unit, and a prompt generation unit. The image acquisition units are composed of a plurality of cameras and image sensors installed in various places in a facility, and are installed in all places where movement and activities of a kindergartener are assumed, such as a corridor, a childcare room, a dining room, a toilet, a bedroom, a kindergarten yard, an entrance, stairs, a playroom, and a bus pickup/drop-off entrance, whereby all activity statuses such as walking, a fall, wandering, eating and drinking, excretion, sleeping, playing, going out, and returning home of the kindergartener can be acquired in chronological order without omission. For example, when the kindergartener falls while walking in the corridor, the image acquisition units can immediately capture the motion and transmit image data to a server, and can detect an abnormality in a chewing or swallowing motion during a meal in the dining room, detect a change in a body movement or a breathing pattern during sleep in the bedroom, and detect a long-time stay or an unnatural posture in the toilet. Specifically, the system arranges each of these modules as an independent process on a memory space of the server. The system exchanges data between the modules at high speed using an inter-process communication mechanism. The image acquisition units execute an algorithm for dynamically controlling a frame rate and an exposure time of the cameras according to illuminance of an installation place and a moving speed of an object. The image acquisition units apply a background subtraction method to the acquired raw image data on the edge side to extract bounding box coordinates of a moving object region. The image acquisition units compress and transmit only a frame in which a moving object is detected to the server. The system dramatically reduces consumption of a network bandwidth by this adaptive image processing. The system brings about a technical effect of reducing a CPU load of an image analysis process on the server side. The system executes an anonymization process of irreversibly converting the image data into a silhouette image or skeleton coordinate data and then transmitting the data in a place requiring consideration for privacy such as a private room of a toilet. The system is applied to a sensitive use case requiring both security and watching over. The system optimizes efficiency of the entire system by closely linking hardware control and software data processing.

The biological information acquisition unit is composed of a wearable terminal worn by the kindergartener, and an optimal terminal can be selected according to the age, activity characteristics, allergies, and skin condition of the kindergartener, such as a wristband-type terminal, a clothing-integrated sensor, a shoe-built-in sensor, a neck-hanging-type terminal, and an ear-hanging-type terminal. The biological information acquisition unit can acquire a wide variety of biological information in real time, such as a heart rate, a body temperature, a blood oxygen concentration, a respiratory rate, an activity amount, an acceleration, position information, a sweating amount, a skin temperature, a skin potential, a body movement during sleep, fall detection, an immobility time, a number of steps, a posture, and a voice (such as a cough or a crying voice). For example, when the kindergartener's breathing becomes shallow during a nap, a change in the respiratory rate or the body movement can be detected, a change in the heart rate or the sweating amount when performing strenuous exercise during play can be acquired, the position information can be immediately specified when deviation outside the facility occurs, and an acceleration or a posture change at the time of a fall can be detected. Specifically, the biological information acquisition unit incorporates a multi-sensor fusion processor that integrates signals from a plurality of heterogeneous sensors. The terminal executes clock control for synchronizing sampling timings of the respective sensors in units of microseconds. The terminal amplifies the acquired analog signal by a built-in amplifier circuit and then converts the signal into a digital data array. The terminal assigns an accurate time stamp and a sensor identifier to each data point. The terminal separates a gravity component from data of a 3-axis acceleration sensor to calculate a pure dynamic acceleration vector. The terminal removes body movement noise from data of an optical heart rate sensor by an adaptive filter to calculate an accurate pulse interval time. The system completes these advanced signal processings on the edge side. The system enhances purity of information while minimizing an amount of data transmitted to the server. The system exhibits a technical effect of continuing highly accurate biological monitoring while suppressing battery consumption of the terminal. The system realizes extremely reliable data collection in a use case where environmental conditions are severe and noise is likely to be mixed, such as vital monitoring by a waterproof sensor during water play and temperature measurement inside clothing in a heavily clothed state in winter.

The data aggregation unit has a function of aggregating the data transmitted from the image acquisition units and the biological information acquisition unit in real time and storing the data in a time-series database. For example, a daily activity history and vital data can be accumulated for each kindergartener, and a past abnormality occurrence history and a transition of a health condition can be centrally managed. The data aggregation unit also has a function of processing a large amount of data simultaneously transmitted from a plurality of kindergarteners at high speed and accurately, and automatically correcting data loss or an abnormal value. For example, even when data is temporarily interrupted during a communication failure, interpolation processing can be performed from preceding and succeeding data, and the data can be provided to an analysis unit as continuous data. Specifically, the data aggregation unit adopts a hybrid data management architecture combining an in-memory database and a persistent storage. The aggregation unit receives a data stream asynchronously transmitted from thousands of terminals in a publish-subscribe model using a distributed message queue system. The aggregation unit verifies a sequence number of a received data packet to detect a packet loss. When data loss occurs, the aggregation unit executes a spline interpolation algorithm or a linear interpolation algorithm to mathematically estimate and complement a numerical value of a missing section. The aggregation unit detects a statistical outlier using a Z-score method and removes the outlier as noise. The aggregation unit formats the cleansed data as a multidimensional time-series tensor and inserts the data into the database. The system executes this series of data preprocessing pipelines at high speed on a memory. The system eliminates a bottleneck of disk IO. The system brings about a technical effect of constantly supplying a high-quality and continuous data set to a subsequent AI analysis process. The system is applied to a use case where robustness of data processing is extremely important, such as operation in a facility with an unstable network environment or traffic concentration during a large-scale event in which hundreds of kindergarteners act all at once.

The generative AI processing unit has a function of integrally analyzing the image data and the biological information data received from the data aggregation unit, and automatically generating a normal range and an activity pattern for each kindergartener. For example, using image recognition AI, a walking pattern, a falling motion, a chewing or swallowing motion during a meal, a posture or motion during excretion, a body movement or breathing pattern during sleep, an abnormal behavior during play, wandering or deviation outside the facility, a fall risk on stairs, and the like of the kindergartener can be determined with high accuracy. In addition, the generative AI can learn a past activity history and vital data accumulated for each kindergartener, and automatically generate an individual normal range. For example, for a kindergartener whose heart rate is higher than usual, a normal range optimized for the kindergartener can be set to prevent an excessive alert. Furthermore, using an abnormality detection algorithm, the generative AI can analyze a plurality of abnormal patterns in real time, such as a rapid increase in a heart rate, an abnormal increase in a body temperature, detection of a falling motion, a case of not returning from a toilet for a long time, respiratory arrest during sleep, a violent crying voice or screaming voice during play, deviation outside the facility, and simultaneous abnormal behaviors of a plurality of kindergarteners, to detect an abnormality. Specifically, the generative AI processing unit extracts spatiotemporal features of a moving image using a three-dimensional convolutional neural network. The processing unit models a positional relationship and interaction among a plurality of kindergarteners as a mathematical graph structure using a graph neural network. The processing unit receives a vital data array for the past 30 days as input data. The processing unit receives a skeleton coordinate tensor indicating a current posture as input data. The processing unit estimates a probability density distribution of normal data for each kindergartener using a Gaussian mixture model. The processing unit calculates a Mahalanobis distance between the current input data and a normal distribution. The processing unit outputs a score array from 0.0 to 1.0 indicating an occurrence probability of each abnormal pattern as output data. The processing unit outputs a heart rate abnormality score of 0.91 as a specific example of the output data. The processing unit outputs a fall abnormality score of 0.85. The processing unit outputs a group panic abnormality score of 0.78. The processing unit transmits these scores to a subsequent abnormality determination unit. The subsequent abnormality determination unit determines presence or absence of final alert issuance based on the received score array. The system accurately identifies a complex abnormal pattern by nonlinear separation in a high-dimensional space. The system exhibits a technical effect of dramatically reducing false detection by dynamic threshold setting in consideration of individual differences. The system is applied to a use case of realizing detailed watching over tailored to characteristics of each individual in a childcare environment where children of different ages at different developmental stages coexist.

The abnormality determination unit has a function of determining presence or absence of an abnormality and an urgency level based on an analysis result by the generative AI processing unit. For example, if there is a rapid decrease in a heart rate simultaneously with fall detection, it can be determined as a serious accident, and immediate reporting to a medical institution can be instructed. Conversely, in a case of a relatively minor abnormality such as a minor fever or temporary immobility, a notification destination and a notification content can be automatically optimized, such as only performing notification to a childcare worker. The abnormality determination unit automatically determines the urgency level of the abnormality by combining a plurality of data sources, and determines a specific abnormality content, for example, “Kindergartener A fell and temporarily lost consciousness.”, “Kindergartener B's body temperature rose to 38.2 degrees.”, and “Kindergartener C may have gone outside the facility.” Specifically, the abnormality determination unit executes an ensemble learning model using a gradient boosting decision tree algorithm. The model receives a plurality of abnormality score arrays output from the generative AI processing unit as input data. The model receives a differential value vector indicating a change rate of vital data for the latest 5 minutes as input data. The model receives an integer value indicating a duration of an abnormal state as input data. The model combines these feature amounts to calculate a nonlinear decision boundary. The model applies a softmax function to calculate a probability distribution belonging to each class from urgency level 1 to 5. The model outputs an integer value of an urgency level with the highest probability as output data. The model outputs a category code indicating a root cause of the abnormality as output data. The model outputs urgency level 5 as a specific example of the output data. The model outputs urgency level 2. The model outputs a cause code “fall/consciousness disorder”. The processing unit passes the output urgency level and cause code to a subsequent communication control unit. The subsequent communication control unit dynamically generates an optimal notification destination list according to the urgency level by referring to a threshold matrix expanded on a memory in advance. The system eliminates false detection of a single sensor by integrally evaluating a plurality of pieces of sensor information. The system brings about a technical effect of eliminating a delay or fluctuation due to human subjective judgment and always executing rapid triage based on a constant standard. The system is applied to a use case of supporting decision-making in a state of extreme tension, such as prioritization when a plurality of accidents occur simultaneously and an instruction of an accurate initial response to an inexperienced childcare worker.

The communication control unit has a function of controlling information transmission to a medical institution, an emergency contact family member, a childcare worker terminal, an administrator terminal, and the like based on a determination result by the abnormality determination unit. For example, a name, an age, a current position, an abnormality content, an occurrence time, latest vital data, an activity history, image data, a past health condition, medical history information, allergy information, medication information of the kindergartener, a name of a responding childcare worker, a response start time, and the like can be transmitted to the medical institution as an automatically generated report. An occurrence of an abnormality can be notified to the family member in real time by a desired means such as a smartphone notification, an email, a voice call, an SNS notification, and an automatic response by a chatbot. An abnormality content and a recommended countermeasure for each kindergartener can be immediately notified to the childcare worker terminal and the administrator terminal to prompt a rapid on-site response. Specifically, the communication control unit executes an external system cooperation module using a RESTful API. The control unit formats data to be transmitted into a structured JSON payload. The control unit inserts a highly urgent message at the head of a queue using a priority queuing algorithm. The control unit monitors a congestion state of a network and dynamically performs bandwidth control. The control unit executes a retransmission control mechanism using an exponential backoff algorithm when transmission fails. The control unit receives the urgency level and the cause code passed from the abnormality determination unit as input data. The control unit receives detailed medical profile data of the kindergartener acquired from a database as input data. The control unit generates and transmits a data package in an HL7 format optimized for an electronic medical record system of the medical institution as output data. The control unit generates and transmits a payload for push notification for a guardian's smartphone as output data. The control unit outputs a 500 KB medical report file including a vital history as a specific example of the output data. The control unit outputs a lightweight push notification text of 128 bytes. As subsequent processing, the control unit waits for a receipt confirmation ACK signal from each transmission destination and records an arrival confirmation log in the database. The system integrally manages diverse communication protocols and guarantees reliable transmission of information. The system exhibits a technical effect of preventing a fatal information transmission error due to a packet loss or a communication delay. The system is applied to a use case of functioning as an information hub in an emergency situation where every moment counts, such as shortening of a transportation time by providing accurate information to an ambulance crew and appropriate information disclosure to a guardian in a panic state.

The notification unit has a function of transmitting information in an optimal format to each notification destination in accordance with an instruction from the communication control unit. For example, detailed health information can be transmitted to a medical institution in a format for electronic medical record cooperation, a status explanation can be transmitted to a family member in easy-to-understand Japanese or multiple languages, notification can be performed to a childcare worker terminal by an alert sound or vibration when an immediate response is required, and notification including statistical information and a past abnormality history can be performed to an administrator terminal. The notification unit also has an automatic generation function of a notification content, and generative AI automatically generates an optimal text, image, graph, voice message, and the like according to a situation, and transmits them to each notification destination. Specifically, the notification unit includes a multilingual translation processing engine using a large language model and a text-to-speech synthesis engine. The notification unit receives a base text character string passed from the communication control unit as input data. The notification unit receives device profile information of a receiver as input data. The notification unit receives a language setting flag of the receiver as input data. The notification unit generates a dynamic graph in an SVG format indicating a transition of vital data using a data visualization library. The notification unit outputs a text character string translated into English or Chinese as output data. The notification unit outputs a synthesized voice waveform data array as output data. The notification unit outputs a rendered graph image file as output data. The notification unit outputs an English text message starting with “Emergency Alert” as a specific example of the output data. The notification unit outputs voice alert data with a sampling rate of 44.1 kHz. The notification unit outputs image data of a line graph indicating a transition of a heart rate. The processing unit optimizes and transmits the generated multimedia data in accordance with specifications of each device. As subsequent processing, a terminal on a receiving side executes hardware interrupt processing of screen display or voice reproduction based on the received data. The system provides information in a most recognizable format without depending on a situation of an information receiver or a constraint of a device. The system brings about a technical effect of reducing a cognitive load of the receiver and dramatically improving a speed of information understanding. The system is applied to a use case requiring reliable information transmission under diverse environments, such as a strong vibration notification to a smart watch in a noisy kindergarten yard and voice reading via a car stereo to a guardian who is driving.

The management terminal unit is a terminal used by a childcare worker or an administrator, and has a function of receiving a notification from the server, a function of monitoring a state of a kindergartener in real time, a function of instructing an additional response when an abnormality occurs, a browsing function of vital data and an activity history for each kindergartener, a display function of a basis of abnormality determination by generative AI and a recommended countermeasure, a management function of a contact history to a guardian, a management function of a cooperation history with a medical institution, an automatic generation function of a health record of the kindergartener, an information sharing function among childcare workers, a visualization function of a behavior pattern and a health tendency of the kindergartener, and the like. For example, the childcare worker carries a tablet terminal or a smartphone terminal, and can immediately check the vital data and the activity history for each kindergartener. In addition, since the basis of the abnormality determination by the generative AI and the recommended countermeasure are also displayed on the terminal, the childcare worker can respond quickly and accurately. Specifically, the management terminal unit implements an offline browsing function using a local cache and a role-based access control mechanism. The terminal asynchronously synchronizes data in a JSON format received from the server with an internal local database. The terminal continues screen rendering using cache data even when a network connection is interrupted. The terminal receives biometric authentication data or a password hash of the childcare worker as input data. The terminal receives a latest abnormality score array push-delivered from the server as input data. The terminal receives a text array of the recommended countermeasure as input data. The terminal generates a dedicated dashboard screen according to an authority level as output data. The terminal renders a UI component that blinks an abnormality occurrence location as output data. The terminal outputs a pin icon on a floor map indicating a current position of the kindergartener as a specific example of the output data. The terminal outputs a step-by-step navigation screen indicating a response procedure. The terminal outputs a timeline view indicating a past response history. The processing unit detects a touch operation event of a user and executes subsequent screen transition processing and a status update request to the server. The system minimizes a CPU load and memory consumption by optimizing rendering processing on the terminal side. The system exhibits technical effects of speeding up an operation response and extending a battery drive time. The system is applied to a robust use case capable of withstanding severe usage conditions in the field, such as data confirmation in a basement where a communication environment is unstable and a multiple access environment where a plurality of childcare workers simultaneously refer to information of different kindergarteners.

The record management unit has a function of recording and managing an activity history, a health record, an abnormality occurrence history, a response history, a notification history, a guardian contact history, a medical institution cooperation history, and the like for each kindergartener in chronological order. For example, the number of past fevers and falls, a change in a sleep pattern, a transition of an eating amount, a change in the number of excretions, a response history of a childcare worker, a contact content to a guardian, a reporting content to a medical institution, and the like can be recorded in detail, and searched, extracted, and analyzed as necessary. The record management unit is also utilized as learning data for the generative AI, and can be useful for future risk prediction and preventive measure proposal. Specifically, the record management unit is implemented as a distributed time-series database system. The database system adopts a column-oriented data structure using a time stamp as a primary key. The record management unit asynchronously writes thousands of sensor data and event logs per second. The system uses an in-memory message queuing system to prevent a delay in writing processing. The record management unit automatically formats the accumulated data as a dataset for fine-tuning a large language model. The processing unit executes morphological analysis and named entity extraction on text data. The processing unit maps the extracted feature words to a multidimensional vector space. The system inputs this vector data to an autoregressive neural network. Input data to the neural network is a time-series array indicating vital fluctuations for the past 30 days and a text embedding vector of a response history. The number of dimensions of the input data is, for example, a 512-dimensional floating-point number array. The neural network calculates a hidden state of the input vector group. An output of the model is a continuous value score from zero to one indicating a specific disease onset probability within one week in the future. The system generates a preventive alert when the output score exceeds a predetermined threshold. As a technical effect, not limited to mere data accumulation, predictive intervention through pattern recognition in a high-dimensional space becomes possible. With this configuration, resource allocation of the entire computer system is optimized. The system also functions as a data cooperation platform with an electronic medical record system of a medical institution.

The prompt generation unit has a function of automatically generating a prompt text for instructing the generative AI to perform optimal analysis and notification text generation. For example, specific prompt texts are automatically generated, such as “Determine how high a risk of a current abnormal value is from a transition of a heart rate and a body temperature of kindergartener A for the past one week”, “Generate an emergency reporting text for a medical institution based on image data and vital data when kindergartener B falls”, “Evaluate a possibility of sleep apnea from body movement data and respiratory rate data during sleep of kindergartener C, and create a response instruction text for a childcare worker”, and “Generate a status explanation text for a family member based on position information and a past behavior pattern when kindergartener D goes outside the facility”, and by inputting them to the generative AI, optimal analysis and notification text generation according to a situation are realized. Specifically, the prompt generation unit includes a dynamic template synthesis engine using natural language processing technology. The generation unit converts numerical data and an image analysis result acquired from a sensor into structured data. The system encodes this structured data into a text format based on a predefined semantic rule. The prompt generation unit executes summarization processing of input information in order to avoid a context window limitation of a large language model. The processing unit preferentially extracts highly urgent vital fluctuation data using an importance scoring algorithm. The system arranges the extracted data at a head portion of a prompt. Input data generated by the prompt generation unit is a text token sequence composed of a system prompt, context data, and a task instruction text. Specific examples of the input data include a heart rate time-series array of a kindergartener, a floating-point number of a body temperature, and a posture estimation vector extracted from an image. The large language model applies a self-attention mechanism to the input token sequence. An output of the model is a set of appearance probability distributions for each vocabulary. The system sequentially selects a token with the highest probability to generate a notification text in a natural language. Specific examples of the output data include a structured text including triage information for a medical institution and a plain status explanation text for a guardian. The system transfers the output text to a subsequent communication control unit. As a technical effect, time for a human to manually explain a situation is eliminated, and an advanced text understanding a context from mechanical data can be instantaneously generated. With this configuration, information transmission latency in an emergency is dramatically reduced.

In this way, the system according to the present embodiment organically links the image acquisition units, the biological information acquisition unit, the data aggregation unit, the generative AI processing unit, the abnormality determination unit, the communication control unit, the notification unit, the management terminal unit, the record management unit, and the prompt generation unit, thereby watching over the safety and health of the kindergartener on a 24-hour basis, realizing a quick and accurate response and information transmission when an abnormality occurs, and simultaneously achieving burden reduction of the childcare worker, improvement of a sense of security of the guardian, and optimization of facility operation. Specifically, the system adopts a microservice architecture composed of a plurality of computing nodes. The system deploys each processing unit as an independent container on a virtualized environment. This configuration prevents the entire system from stopping even when a load is concentrated on a specific processing unit. The system performs primary processing on high-frequency stream data flowing from the image acquisition units and the biological information acquisition unit in an edge computing layer. The edge processing unit executes noise removal and data compression. The system transfers the compressed data to the data aggregation unit in a cloud environment. The generative artificial intelligence processing unit operates on a parallel computing cluster using a graphics processing unit. The processing unit makes a deep learning model having hundreds of millions of parameters resident on a memory. The abnormality determination unit evaluates an inference result of the artificial intelligence in milliseconds. The system activates an event-driven notification process at the moment an abnormality is detected. As a technical effect, power consumption and a communication bandwidth of the entire system can be optimized while processing a huge amount of multimodal data in real time. The system enables correlation analysis of multidimensional data exceeding the limit of human monitoring capability. This configuration is applied to a large-scale childcare facility or a wide area network system that integrally manages a plurality of facilities.

### (Implementation Steps)

### Step 1: Kindergartener Information and Terminal Registration

When a new kindergartener enters a childcare facility, basic information such as a name, an age, a medical history, an allergy, an emergency contact, and guardian information of the kindergartener is registered in the system from the management terminal unit, and a wearable terminal is assigned to each kindergartener. A type of the terminal is selected according to the age and health condition of the kindergartener, such as a wristband-type, a clothing-integrated type, a shoe-built-in type, and a neck-hanging-type, and a terminal ID and a kindergartener ID are linked and registered in the system. At the time of registration, an operation check and a communication test of the terminal are also performed to confirm that the data aggregation unit can normally receive data. Specifically, the system establishes an advanced encrypted communication protocol in a terminal registration process. The management terminal unit issues a unique digital certificate to the newly assigned wearable terminal. The system constructs a secure communication channel between the terminal and the server using public key cryptography. The processing unit links a hardware identifier of the terminal and anonymized profile data of the kindergartener. The system obfuscates data using a hash function for personal information protection. In the registration process, the system automatically executes initial calibration processing. The terminal performs zero-point correction of a built-in acceleration sensor and gyro sensor. The system generates test data and measures an arrival delay time to the data aggregation unit. The processing unit calculates a packet loss rate of a network and dynamically determines an optimal data transmission rate. As a technical effect, even in an environment where a large number of terminals are connected simultaneously, a communication collision can be prevented and a stable data collection platform can be established. With this configuration, device spoofing and data falsification are physically and logically prevented. The system starts a health check process for monitoring a remaining battery level of the terminal and an operating state of the sensor in the background.

### Step 2: Real-Time Acquisition of Image and Biological Information

The image acquisition units are installed in various places in the facility (such as a corridor, a childcare room, a dining room, a toilet, a bedroom, a kindergarten yard, an entrance, stairs, a playroom, and a bus pickup/drop-off entrance), and acquire activity statuses of the kindergartener such as walking, a fall, wandering, eating, excretion, sleeping, play, going out, and returning home in chronological order. In parallel, the biological information acquisition unit acquires a wide variety of biological information such as a heart rate, a body temperature, a blood oxygen concentration, a respiratory rate, an activity amount, an acceleration, position information, a sweating amount, a skin temperature, a skin potential, a body movement during sleep, fall detection, an immobility time, a number of steps, a posture, and a voice of the kindergartener in real time, and transmits them to the data aggregation unit via Bluetooth, a wireless LAN, or the like. Specifically, the image acquisition units are equipped with a plurality of high-resolution complementary metal-oxide-semiconductor image sensors. The sensors continuously capture moving images at 60 frames per second. The image acquisition units include a lightweight convolutional neural network operating on an edge side. The edge artificial intelligence extracts only bounding box coordinates of a person from the acquired image frames. The system significantly reduces an amount of data transmitted to the server by discarding a background image. The biological information acquisition unit transmits data using a short-range wireless communication standard. The terminal optically reads a blood flow change in a capillary blood vessel of the skin using a photoplethysmography sensor. The sensor digitizes a reflected light intensity of a green light emitting diode with an analog-to-digital converter. The system applies a fast Fourier transform to the acquired biological signal. The processing unit specifies a peak frequency of heart rate variability from data in a frequency domain. As a technical effect, physical sensor data can be converted into a high-dimensional digital feature amount and optimized into a format that is easy for a subsequent artificial intelligence model to process. With this configuration, it becomes possible to continuously capture a minute biological change that is impossible by human visual observation or manual measurement. The system packetizes the acquired data together with a time stamp and transmits it as an encrypted payload.

### Step 3: Data Aggregation and Time-Series Management

The data aggregation unit aggregates the data transmitted from the image acquisition units and the biological information acquisition unit in real time, and stores a daily activity history and vital data for each kindergartener in a time-series database. A large amount of data transmitted simultaneously from a plurality of kindergarteners is processed at high speed and accurately, and data loss and an abnormal value at the time of communication failure are automatically corrected. For example, even when respiratory rate data during a nap is temporarily interrupted, interpolation processing is performed from preceding and succeeding data, and it is provided to the generative AI processing unit as continuous data. Specifically, the data aggregation unit implements a distributed stream processing engine. The processing engine combines data streams arriving asynchronously from a plurality of sensors on a memory. The system executes time axis synchronization with millisecond accuracy based on a time stamp given to each data packet. The data aggregation unit detects an order reversal of data caused by a network delay. The processing unit correctly rearranges the order of the data using a buffer memory. The system executes an algorithm for complementing a missing value due to sensor noise or temporary communication disconnection. The processing unit statistically estimates a numerical value of a missing section using a Kalman filter or a spline interpolation method. The system smooths abnormal spike noise with a moving median filter. As a technical effect, a continuous and highly reliable time-series dataset can be dynamically generated from incomplete raw data. With this configuration, a decrease in inference accuracy in the subsequent generative artificial intelligence processing unit is prevented. The system caches the cleansed data in an in-memory database and simultaneously writes it asynchronously to a persistent storage. This processing eliminates a bottleneck of disk input/output and improves processing throughput of the entire system.

### Step 4: Integrated Analysis and Individual Normal Range Generation by Generative AI

The generative AI processing unit integrally analyzes the image data and the biological information data received from the data aggregation unit, and automatically generates a normal range and an activity pattern for each kindergartener. For example, using image recognition AI, a walking pattern, a falling motion, a chewing or swallowing motion during a meal, a posture or motion during excretion, a body movement or breathing pattern during sleep, an abnormal behavior during play, wandering or deviation outside the facility, a fall risk on stairs, and the like are determined with high accuracy. Furthermore, a past activity history and vital data accumulated for each kindergartener are learned, and an individual normal range is automatically generated. Specific examples of the prompt text to be read by the generative AI include “Determine whether a current vital value is within a normal range based on heart rate, body temperature, and activity amount data of kindergartener A for the past one month”, “Extract a motion with a high fall risk from a walking pattern and a fall history of kindergartener B, and generate an alert text for a childcare worker”, and the like. Specifically, the generative artificial intelligence processing unit adopts a transformer architecture corresponding to multimodal learning. The model projects an image feature vector and a time-series vital data vector into the same latent space. Input data to the artificial intelligence is a time-series tensor of a heart rate, a body temperature, and an acceleration for the past few minutes, and a spatial tensor of skeletal coordinates obtained from a posture estimation model. The number of dimensions of the input data is, for example, a third-order tensor composed of a time axis, a sensor type, and a feature dimension. The model calculates a hidden correlation between a specific motion on an image and a fluctuation of a vital sign using a cross-attention mechanism. Output data from the artificial intelligence is a multidimensional probability distribution vector indicating a probability that a current state belongs to a normal range. Specific examples of the output data include a score for each risk category such as a fall probability of 95 percent and an abnormal fever probability of 10 percent. The system continuously fine-tunes a weight parameter of the model using individual data for each kindergartener. As a technical effect, unlike a conventional method of applying a uniform threshold to all kindergarteners, dynamic abnormality detection adapted to an individual constitution and growth stage becomes possible. With this configuration, a false alarm rate is dramatically reduced, and only a true abnormality can be extracted with high accuracy. The system transfers the output probability score to the subsequent abnormality determination unit.

### Step 5: Abnormality Determination and Urgency Level Evaluation

The abnormality determination unit analyzes a plurality of abnormal patterns in real time, such as a rapid increase in a heart rate, an abnormal increase in a body temperature, detection of a falling motion, a case of not returning from a toilet for a long time, respiratory arrest during sleep, a violent crying voice or screaming voice during play, deviation outside the facility, and simultaneous abnormal behavior of a plurality of kindergarteners, based on the analysis result by the generative AI processing unit, and determines presence or absence of an abnormality and an urgency level. Specific examples of the prompt text to be read by the generative AI include “Determine whether a highly urgent abnormality has occurred from heart rate, body temperature, and acceleration data of kindergartener C for the latest 10 minutes, and propose a necessary countermeasure”, “Evaluate an apnea risk from respiratory rate and body movement data during sleep of kindergartener D, and generate a response instruction text for a childcare worker”, and the like. Specifically, the abnormality determination unit receives the probability distribution vector output from the artificial intelligence. The determination unit executes an algorithm for calculating an abnormality score in a multidimensional space. The system quantifies a degree of an outlier from a normal data group using an isolation forest or a reconstruction error of an autoencoder. Input data to the abnormality determination unit is a probability value of each risk category calculated by the generative artificial intelligence and a latest vital fluctuation rate. The determination unit calculates a weighted linear sum for these input values to calculate a comprehensive urgency score. Output data is an urgency level represented by an integer value from zero to 100, and a corresponding action code. As a specific example of the output data, structured data such as an urgency level of 90 and an action code “immediate emergency request” is generated. The system generates interrupt processing when the urgency score exceeds a preset dynamic threshold. As a technical effect, a plurality of minute signs of abnormality can be mathematically integrated, and a complex risk that a human cannot intuitively determine can be instantaneously evaluated. With this configuration, objective and quick triage utilizing computing capability of a computer is realized. The system writes a determination result in a shared area on a memory, and transmits a signal to the communication control unit.

Step 6: Automatic Notification and Information Transmission at the Time of an Abnormality

The communication control unit controls information transmission to a medical institution, an emergency contact family member, a childcare worker terminal, an administrator terminal, and the like based on a determination result by the abnormality determination unit. The notification unit transmits the name, age, current position, abnormality content, occurrence time, latest vital data, activity history, image data, past illness information, allergy information, medication information, name of a responding childcare worker, response start time, and the like of the kindergartener to the medical institution as an automatically generated report, notifies the family member of the occurrence of the abnormality in real time by a smartphone notification, an e-mail, a voice call, an SNS notification, an automatic response by a chatbot, or the like, and immediately notifies the childcare worker terminal and the administrator terminal of the abnormality content and a recommended countermeasure. Specific examples of a prompt sentence to be read by the generative AI include “Generate an emergency reporting text for a medical institution when a kindergartener E falls and a heart rate rapidly decreases” and “Generate a status explanation text for a family member when a body temperature of a kindergartener F rises to 38.5 degrees”. Specifically, the communication control unit functions as an event-driven message broker. Upon receiving a signal from the abnormality determination unit, the control unit immediately refers to a routing table. The present system dynamically selects an optimal notification destination and communication protocol according to an urgency level and a type of the abnormality. The notification unit calls an external application programming interface to execute data transmission. Input data to the notification unit is a structured payload including an action code generated by the abnormality determination unit, an identifier of the kindergartener, and the latest vital data. The notification unit inputs this payload to a natural language generation model. Output data from the model is a text message optimized for an attribute of a receiver. As a specific example of the output data, detailed vital transition data using technical terms is generated for the medical institution, and a text with plain expressions that reduces anxiety is generated for a guardian. The present system encrypts the generated text and transmits it to each terminal via a push notification protocol. As a technical effect, data can be automatically converted into an optimal format tailored to an information receiver, and both accuracy and promptness of information transmission can be achieved. With this configuration, a communication error in an emergency is eliminated at a system level.

### Step 7: Response and Record Management by a Childcare Worker and an Administrator

The childcare worker or the administrator receives the abnormality notification using a terminal unit, and implements an on-site response. For example, at the time of a fall, consciousness confirmation of the kindergartener and first aid are performed, at the time of fever, hydration and a rest instruction are performed, and at the time of deviation outside the facility, rushing to the site and securing the kindergartener are performed. A response content and progress are input from an administrator terminal unit to a record management unit, and an activity history, a health record, an abnormality occurrence history, a response history, a notification history, a guardian contact history, a medical institution cooperation history, and the like for each kindergartener are recorded and managed in chronological order. Specifically, the administrator terminal unit includes a bidirectional data communication interface. The terminal unit transmits response data input on-site by the childcare worker who has received the notification to a server in real time. The present system is equipped with a voice recognition engine, and automatically converts an utterance of the childcare worker into text data. The processing unit extracts keywords indicating the response content, a used medical instrument, and a post-event state of the kindergartener from the input text using a natural language processing technology. The record management unit stores the extracted keywords in a database as structured tags. The present system links sensor data at the time of abnormality detection, an inference log of artificial intelligence, and a human response history as a single transaction. As a technical effect, a series of processes from occurrence of an event to resolution thereof is completely digitized, and a post-audit and analysis are facilitated. With this configuration, a non-technical operation such as handwritten report creation is eliminated, and accuracy of data input is improved. The present system utilizes the accumulated response history data as correct answer labels for learning of a next-generation artificial intelligence model. By this processing, a feedback loop in which inference accuracy of the entire system autonomously improves is formed.

### Step 8: Operation Optimization and Preventive Measure Proposal by Generative AI

Based on the data accumulated in the record management unit, the generative AI processing unit automatically implements operation optimization of the entire facility, future risk prediction, and preventive measure proposal. For example, it analyzes an activity pattern and a health condition tendency of the kindergartener, and performs an optimization proposal for a shift and placement of childcare workers, a notification of an accident-prone tendency in a specific time zone or place, an automatic update of a monitoring standard and a notification content according to a change in growth or a health condition, automatic generation of a detailed explanation and advice in response to an inquiry from a guardian, and the like. Specific examples of a prompt sentence to be read by the generative AI include “Propose a risk prediction and a preventive measure for the next one month from a fall occurrence tendency of all kindergarteners in the past one year” and “Generate an instruction sentence for automatically updating a monitoring standard and a notification content according to a change in a health condition of a kindergartener G”. Specifically, the generative artificial intelligence processing unit applies unsupervised learning and reinforcement learning algorithms to the accumulated big data. The present system executes clustering processing on past incident data. The processing unit analyzes a data distribution in a multidimensional space, and specifies a combination of a time zone, a place, and an environmental condition in which an accident is likely to occur. Input data to the artificial intelligence is vital time-series data, a position information log, and a text vector of a response history of all kindergarteners in the past one year. Output data from the model is a risk probability map in a specific future period, and a recommended parameter group for resource optimization. As a specific example of the output data, prediction data indicating that a fall risk in a specific playroom increases by thirty percent between 2:00 p.m. and 3:00 p.m., and numerical data indicating an optimal number of childcare workers to be placed in the corresponding time zone are generated. The present system dynamically changes a frame rate of a monitoring camera and a sampling rate of a sensor based on this prediction data. As a technical effect, the system can autonomously execute a data-driven preventive intervention, not limited to a post-response. With this configuration, operational efficiency of the entire facility is mathematically optimized, and maximum safety can be ensured with limited resources.

### (Specific Use Case)

For example, a case is assumed where a kindergartener shows an abnormal body movement during an afternoon nap in a childcare facility. The image acquisition units acquire a body movement pattern of the kindergartener in chronological order by a camera installed in a bedroom, and the biological information acquisition unit acquires vital data such as a heart rate, a body temperature, a respiratory rate, a blood oxygen concentration, and a body movement amount from a wearable terminal of the kindergartener in real time. A data aggregation unit immediately aggregates these data, and the generative AI processing unit integrally analyzes the image data and the vital data. The generative AI has learned a history of past sleep data, body movement patterns, and vital data for each kindergartener, and automatically generates an individual normal range. In this case, it is detected that the body movement significantly increases and the heart rate also exceeds a reference value compared to a normal afternoon nap. The generative AI determines to the abnormality determination unit that “simultaneous occurrence of a body movement increase and a heart rate increase is highly likely to be a sign of fever, a sleep disorder, or poor physical condition”. The abnormality determination unit evaluates an urgency level, and transmits a notification instructing the childcare worker terminal to perform immediate on-site confirmation. The notification unit displays “Abnormal body movement and heart rate increase detected during afternoon nap of kindergartener. Implement on-site confirmation immediately” on the childcare worker terminal, and simultaneously displays a comparison graph with past sleep data and grounds for abnormality detection on the administrator terminal unit. The childcare worker confirms the physical condition of the kindergartener on-site, and implements body temperature measurement and contact to a medical institution as necessary. An abnormality detection time, vital data, an on-site response content, and a response history of the childcare worker are automatically recorded in the record management unit. Specifically, the present system synchronously processes a multimodal data stream in order to monitor a state of the kindergartener during an afternoon nap. The image acquisition unit captures an outline and a minute body movement of the kindergartener in a dark place as a change in a pixel value using an infrared camera. The biological information acquisition unit acquires R-R interval data of a heart rate and three-axis acceleration data from the wearable terminal. Input data to the generative artificial intelligence processing unit is a two-dimensional tensor of an optical flow extracted from an image, and a one-dimensional time-series array of vital data. As a specific example of the input data, a heart rate variability vector sampled at a frequency of ten times per second is included. The artificial intelligence executes inference using an ensemble model combining a convolutional neural network and a long short-term memory network. Output data from the model is a probability score corresponding to a specific disease such as sleep apnea syndrome or febrile seizure. As a specific example of the output data, a numerical value indicating that a probability of a seizure is eighty-five percent is output. The abnormality determination unit determines that this score has exceeded a threshold value, and immediately generates an interrupt signal. The present system transmits a push notification including a graph drawing command of a vital waveform to the childcare worker terminal. As a technical effect, a sign of a serious disease can be discovered early from a minute change in a biological signal even in a situation where visual observation is impossible due to darkness or being hidden by a futon. With this configuration, human monitoring capability is complemented, and a fatal risk is reduced.

Also, for example, when a chewing motion stops while a kindergartener is eating a meal in a dining room and a sudden movement is detected by an acceleration sensor, the image acquisition units capture the chewing stop and an unnatural posture from a camera video of the dining room, and the biological information acquisition unit acquires a rapid increase in a heart rate and a change in a respiratory rate. The generative AI processing unit integrally analyzes the image data and the vital data, and determines that “a chewing stop and a rapid heart rate increase during a meal have a high risk of aspiration or choking”. The abnormality determination unit sets an urgency level to the highest level, and transmits an immediate emergency notification to a medical institution and a guardian via the communication control unit. The notification unit transmits an automatically generated report stating “Kindergartener shows chewing stop and rapid heart rate increase during meal, and choking is suspected. Current position is dining room, name of responding childcare worker, latest vital data, and image data are attached” to the medical institution, and transmits a status explanation text stating “Abnormality detected while kindergartener is eating meal. Childcare worker is currently responding, and medical institution has also been contacted” to the guardian. An alert stating “Choking risk of kindergartener detected. Implement response immediately” is displayed on the childcare worker terminal. All data from occurrence of the abnormality to completion of the response are recorded in chronological order in the record management unit. Specifically, the present system executes a dedicated algorithm for detecting an aspiration or choking risk during a meal. The image acquisition unit extracts landmark coordinates of a head and a face of the kindergartener in real time from a camera installed in the dining room. The processing unit calculates a frequency of an up-and-down movement of a jaw accompanying chewing using a posture estimation model. The biological information acquisition unit detects a decrease in a blood oxygen concentration and a rapid fluctuation in a heart rate. Input data to the generative artificial intelligence processing unit is a numerical vector indicating a movement frequency of the jaw, and time-series data of the blood oxygen concentration. As a specific example of the input data, a tensor indicating a state in which the chewing frequency has decreased to zero hertz and the blood oxygen concentration has decreased to less than ninety percent is input. Output data from the artificial intelligence is a floating-point number indicating a probability of airway obstruction and an urgency level flag. As a specific example of the output data, a binary flag indicating a choking probability of ninety-nine percent and the highest urgency level is output. Using this flag as a trigger, the present system executes an API call for directly transmitting data to a system of the medical institution. As a technical effect, a lifesaving process can be started in milliseconds without human judgment for an event such as choking that has no time to spare. With this configuration, high-speed responsiveness of a computer system is maximized in a situation where a delay in data processing directly leads to a life crisis.

Furthermore, for example, when a kindergartener falls while playing in a kindergarten yard, a large impact is detected by an acceleration sensor, and the image acquisition units capture a falling motion, the biological information acquisition unit acquires a heart rate decrease and a change in a consciousness level immediately after the fall. The generative AI processing unit integrally analyzes the falling motion and a sudden change in vital data, and determines that “a risk of head trauma or a consciousness disorder due to a fall is high”. The abnormality determination unit sets an urgency level high, and performs simultaneous notification to a medical institution, a guardian, and a childcare worker terminal via the communication control unit. The notification unit transmits an automatically generated report stating “Kindergartener fell in kindergarten yard, and heart rate decrease and consciousness level change detected. Current position is kindergarten yard, name of responding childcare worker, latest vital data, and image data are attached” to the medical institution, and transmits a status explanation text stating “Kindergartener fell in kindergarten yard, and childcare worker is currently responding. Medical institution has also been contacted” to the guardian. An alert stating “Serious risk due to fall detected. Implement on-site response immediately” is displayed on the childcare worker terminal. All data from occurrence of the abnormality to completion of the response are recorded in detail in the record management unit. Specifically, the present system integrates a physical calculation model for detecting a dynamic accident in an outdoor environment. The biological information acquisition unit acquires rapid impact data exceeding gravitational acceleration from an acceleration sensor and a gyro sensor of a wearable terminal. The processing unit calculates a vector direction and a magnitude of an impact in a three-dimensional space. The image acquisition unit tracks a movement trajectory of the kindergartener from a wide-angle camera video of the kindergarten yard, and detects a rapid altitude decrease. Input data to the generative artificial intelligence processing unit is a time-series tensor indicating an impact waveform, and an image feature amount vector indicating a posture change before and after a fall. As a specific example of the input data, numerical data indicating that an impact force on a head has exceeded fifty G is included. Output data from the artificial intelligence is categorical data classifying severity of head trauma or a bone fracture. As a specific example of the output data, labels such as high concussion risk and medium cervical spine injury risk are output. The present system executes a logical determination as to whether an ambulance request is necessary based on this classification result. As a technical effect, a mere fall and a fall accompanied by serious trauma can be accurately distinguished based on physical data. With this configuration, it becomes possible to immediately allocate a medical resource to a truly urgent situation while reducing an unnecessary ambulance request.

Specific examples of a prompt sentence to be read by the generative AI include “When a body movement increase and a heart rate increase simultaneously occur during an afternoon nap of a kindergartener, compare with past sleep data, and determine presence or absence of an abnormality and a recommended countermeasure”, “When a chewing stop and a rapid heart rate increase during a meal are detected, evaluate presence or absence of a choking risk, and generate an emergency reporting text for a medical institution”, and “When a falling motion and a heart rate decrease in a kindergarten yard are simultaneously detected, evaluate a head trauma risk, and generate a status explanation text for a guardian”. Specifically, the prompt generation unit implements a prompt engineering technology for maximizing an inference capability of a large language model. The present system embeds a past similar case and an optimal countermeasure thereof into a prompt as a context using a few-shot prompting method. Input data to the prompt generation unit is raw data of various sensors output from the abnormality determination unit, a category of an abnormality, and individual profile data of the kindergartener. The present system converts these data into a structured text in a JSON format. As a specific example of a prompt created by the generation unit, an instruction sentence such as “Input data tensor: heart rate one hundred fifty, body movement vector abnormal value. Task: Output a probability of a febrile seizure from this time-series data as a percentage, and generate a report in an XML format for a medical institution” is included. Output data from the large language model is text data strictly following a designated format. As a specific example of the output data, a tagged response instruction document that can be directly parsed by the system is generated. As a technical effect, a natural language processing model can be caused to function not merely as a chatbot but as a data conversion and advanced logical inference engine between systems. With this configuration, a pipeline for automatically generating a structured action plan from unstructured data is established.

In this way, the system of the present invention automatically collects and analyzes activity statuses and biological information of a kindergartener multilaterally and in real time, determines presence or absence of an abnormality and an urgency level with high accuracy using generative AI, and automatically generates and transmits an optimal notification text and response instruction to a medical institution, a guardian, a childcare worker terminal, and the like when an abnormality occurs, thereby making it possible to dramatically improve safety and efficiency of a childcare site. Specifically, the present system functions as a distributed processing platform seamlessly integrating an edge device group and a cloud computing environment. The present system realizes high scalability and fault tolerance by performing asynchronous message passing between respective modules. The data aggregation unit and the generative artificial intelligence processing unit include an auto-scaling function of dynamically increasing or decreasing the number of container replicas according to an input data amount. The present system prevents data loss using a local cache and a redundant path even when network disconnection or a partial hardware failure occurs. As a technical effect, system downtime can be brought close to zero to the utmost limit in a mission-critical watching-over operation requiring continuous operation 24 hours a day, 365 days a year. With this configuration, depletion of a computational resource when processing an enormous amount of multimodal data in real time is prevented, and a constant response speed is always guaranteed. The present system provides a versatile architecture applicable to any environment requiring advanced watching-over, such as not only a childcare facility but also an elderly facility and a hospital.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

Embodiments for carrying out the present invention will be described more specifically and in detail. The system of the present invention is configured by organically linking image acquisition units, a biological information acquisition unit, a data aggregation unit, a generative AI processing unit, an abnormality determination unit, a communication control unit, a notification unit, a record management unit, and an administrator terminal unit in order to watch over safety and health of an elderly person or a care receiver on a 24-hour basis in a nursing care facility or a home nursing care site. Specifically, the present system is deployed as a distributed watching-over network architecture optimized for a nursing care facility and a home nursing care environment. The present system implements a dedicated data processing pipeline considering a specific behavior pattern and physical vulnerability of an elderly person. This configuration links an edge server arranged in a local area network and a generative artificial intelligence processing unit on a cloud connected via a wide area network. From a viewpoint of privacy protection, the present system executes real-time masking processing on an edge side for image data acquired in a highly confidential area such as a living room or a bathroom. The processing unit extracts only a silhouette of a person, and immediately discards original image data. As a technical effect, only a spatial feature amount necessary for posture estimation and abnormal motion detection can be safely transferred to a cloud while completely protecting privacy of a care receiver. With this configuration, a risk of data leakage is physically and logically eliminated, and secure system operation satisfying a compliance requirement becomes possible. The present system operates on a multi-tenant cloud infrastructure that integrally monitors a plurality of nursing care facilities.

First, the image acquisition units are composed of a plurality of cameras and image sensors installed in all places such as a living room, a corridor, a bathroom, a toilet, a dining room, a living room, an entrance, a garden, stairs, in front of an elevator, an outdoor passage, a balcony, a common space, a rehabilitation room, a lounge, a washroom, a dressing room, a storage room, in front of a staff room, and near an emergency exit in a facility or a residence. For example, all activity statuses of a care receiver such as walking in a corridor, a fall in a bathroom, a long-time stay in a toilet, an abnormal motion during a meal in a dining room, wandering in a living room, going out from an entrance, stumbling on stairs, getting out of and returning to a bed, deviation outside the facility, wandering at night, movement in a wheelchair, an exercise pattern during rehabilitation, a group activity in a lounge, a fall in a washroom, an unnatural motion in a dressing room, and a suspicious behavior near an emergency exit can be acquired with high accuracy and in chronological order. The image acquisition units can combine various sensors such as an infrared camera, a depth sensor, a wide-angle camera, a fisheye lens camera, a camera integrated with a voice recognition microphone, and an AI-equipped camera, and can flexibly cope with nighttime, a dark place, a blind spot, simultaneous monitoring of a plurality of persons, a privacy-conscious area, and the like. Specifically, the present image acquisition units are configured as a multimodal sensor unit integrating a time-of-flight depth sensor and a thermal image sensor in addition to a visible light camera. The present sensor unit measures a distance to an object for each pixel, and generates three-dimensional point cloud data. The present system calculates a trajectory of a getting-up motion from a bed or a transfer motion to a wheelchair as a space vector using the point cloud data. The present image acquisition units execute a single-pass object detection neural network on an edge device. Input data to the present model is a resized and normalized image tensor. Output data from the present model is bounding box coordinates and a confidence score of an object such as a person, a wheelchair, a cane, and a bed. The present system geometrically analyzes a relative positional relationship between these objects. As a technical effect, a posture and a position of the care receiver can be specified with high accuracy even at night with poor lighting conditions or in an indoor environment with many obstacles. With this configuration, it becomes possible to significantly reduce false detections that frequently occurred in a conventional system depending only on a two-dimensional image, and accurately capture a sign of wandering or a fall as a physical change in a three-dimensional space.

The biological information acquisition unit is composed of a wearable terminal worn by the care receiver and an environment-installed sensor. For example, an optimal terminal or sensor can be selected according to physical characteristics, a health condition, a lifestyle habit, a skin condition, presence or absence of an allergy, presence or absence of dementia, presence or absence of a motor function disorder, a past illness, a medication status, and the like of the care receiver, such as a wristband-type terminal, a clothing-integrated sensor, a shoe-built-in sensor, a neck-hanging-type terminal, an ear-hanging-type terminal, a skin-attached sensor, a hearing aid-integrated sensor, an artificial leg/arm-built-in sensor, a bed mat sensor, a chair-built-in sensor, a toilet seat sensor, a waterproof sensor for bathing, a voice recognition microphone, an exhalation sensor, a weight scale-linked sensor, a blood pressure monitor-linked sensor, a blood glucose level sensor, and a body composition monitor-linked sensor. The biological information acquisition unit acquires a wide variety of biological information in real time, such as a heart rate, a body temperature, a blood oxygen concentration, a respiratory rate, an activity amount, an acceleration, position information, a sweating amount, a skin temperature, a skin potential, a body movement during sleep, fall detection, an immobility time, a number of steps, a posture, a voice (a cough, a groan, a voice calling for help, abnormal vocalization, a breathing sound, a snore, and sleep apnea), a motion during medication, a chewing/swallowing motion during a meal, a motion during excretion, a blood pressure, a blood glucose level, a body weight, a body fat percentage, a muscle mass, a bone density, a urine volume, a stool volume, a urination/defecation time, a body temperature change during bathing, a bathing time, a body movement during bathing, an exercise amount during rehabilitation, and a vital change during rehabilitation. For example, it is possible to immediately detect when breathing becomes shallow during sleep at night, when a walking speed during the day decreases, a body temperature rise during bathing, a chewing stop during a meal, when there is no motion at a scheduled medication time, an acceleration or posture change at the time of a fall, when not moving from a bed or a chair for a long time, an exercise amount decrease during rehabilitation, a rapid increase or decrease in the number of excretions, and when abnormal vocalization or a voice calling for help is detected. Specifically, the present biological information acquisition unit implements a sensor fusion algorithm that integrates data obtained from a plurality of heterogeneous sensors. The present system executes primary filtering of a biological signal using a low power consumption microcontroller built in the wearable terminal. The present processing unit removes body movement noise during walking with an adaptive filter, and extracts a pure electrocardiogram waveform and respiratory waveform. The present biological information acquisition unit includes a non-contact vital measurement device using a millimeter wave radar as the environment-installed sensor. The present radar measures a minute displacement of a chest of the care receiver using a Doppler effect. Input data to the present system is a time-series array of a phase change obtained from a reflected wave of the radar. The present processing unit applies a fast Fourier transform to this data, and separates a respiratory rate and a heart rate as frequency components. As a technical effect, continuous vital monitoring can be performed completely non-contact even for a care receiver who refuses to wear a wearable terminal, such as an elderly person with dementia. With this configuration, data loss due to a dead battery of a device or forgetting to wear it is prevented, and a 24-hour seamless data collection infrastructure is established.

A data aggregation unit aggregates data transmitted from the image acquisition units and the biological information acquisition unit in real time, and stores a daily activity history and vital data for each care receiver in a time-series database. It also has a function of processing a large amount of data transmitted simultaneously from a plurality of care receivers at high speed and accurately, and automatically correcting data loss or an abnormal value at the time of a communication failure. For example, even when data is temporarily interrupted due to a communication failure, interpolation processing can be performed from preceding and succeeding data, and the data can be provided to the generative AI processing unit as continuous data. The data aggregation unit cooperates with a network infrastructure of the entire facility, a cloud server, an edge server, a local server, a data backup device, and the like to ensure safety, reliability, and scalability of data. Specifically, the present data aggregation unit is constructed as a distributed database cluster for efficiently managing large-scale time-series data. The present system includes a data tiering function of automatically moving a storage tier according to an access frequency to data. The present processing unit holds high-resolution data of the latest 24 hours in an in-memory database, and compresses data prior to that to save it to inexpensive object storage. The present data aggregation unit applies a sharding technology for logically separating data transmitted from a plurality of facilities. The present system asynchronously performs data replication for each shard to prevent data loss at the time of a hardware failure. The present processing unit applies a real-time abnormal value detection algorithm to the received data stream. The present system specifies an extreme outlier caused by a sensor failure or a communication error by a statistical method, and assigns an invalid flag. As a technical effect, healthcare data swelling to a petabyte class can be maintained in a state where it can be searched and analyzed at low cost and high speed. With this configuration, a pipeline that stably supplies an always clean and structured data set to the subsequent generative artificial intelligence processing unit is guaranteed.

The generative AI processing unit has a function of integrally analyzing the image data and the biological information data received from the data aggregation unit, and automatically generating a normal range and a behavior pattern for each care receiver. For example, using image recognition AI, a walking pattern, a falling motion, a chewing or swallowing motion during a meal, a posture or motion during excretion, a body movement or breathing pattern during sleep, wandering or deviation outside the facility, a fall risk on stairs, a motion during medication, an abnormal behavior during bathing, abnormal vocalization or a voice calling for help, an exercise pattern during rehabilitation, an abnormal motion during excretion, a change in a meal amount, a change in a water drinking amount, a change in a body weight, a body fat percentage, and a muscle mass, a sudden change in a blood pressure and a blood glucose level, an abnormality in a urine volume and a stool volume, a change in a urination/defecation time, an abnormality in a bathing time, a body movement decrease during bathing, a vital change during rehabilitation, and the like can be determined with high accuracy. Furthermore, the generative AI learns a past activity history and vital data accumulated for each care receiver, and automatically generates an individual normal range. For example, an individual change can be detected with high accuracy, such as when getting up to go to a toilet twice at night usually but getting out of bed five times tonight, when a walking speed is significantly lower than usual, when a body movement during sleep is decreased, when there is no motion at a scheduled medication time, when an exercise amount during rehabilitation rapidly decreases, when a meal amount rapidly decreases, when the number of excretions rapidly increases, when a body weight rapidly decreases, and when a blood pressure or a blood glucose level suddenly changes. The generative AI analyzes a plurality of abnormal patterns such as a falling motion, a wandering pattern, a sign of forgetting to take medication, a sudden physical condition change, long-time immobility, abnormal vocalization, an abnormality during rehabilitation, an excretion abnormality, a meal abnormality, a bathing abnormality, and a sleep disorder in real time to detect an abnormality. Specifically, the present generative AI processing unit implements a multimodal neural network architecture. The present generative AI processing unit maps the image data and the time-series biological information data to the same high-dimensional feature space. The present generative AI processing unit receives a time-series image tensor acquired from a camera as input data. The present image tensor is, for example, a four-dimensional tensor having a frame resolution of 256 pixels square, 3-channel RGB values, and a time axis for 30 frames. The present generative AI processing unit receives a numerical vector of biological information acquired from the wearable terminal as input data. The present numerical vector is, for example, a 128-dimensional time-series array including 3-axis data of a heart rate, a body temperature, and an acceleration. The present generative AI processing unit executes normalization processing on the image tensor as preprocessing. The present generative AI processing unit applies a noise removal filter to the numerical vector of the biological information as preprocessing. The present generative AI processing unit uses a convolutional neural network as an image feature extractor. The present generative AI processing unit uses a long short-term memory network as a biological information feature extractor. The present generative AI processing unit combines the extracted image feature vector and biological information feature vector in a combining layer. The present generative AI processing unit inputs the combined feature vector to a transformer model equipped with a self-attention mechanism. The present transformer model calculates a temporal correlation between different modalities. The present generative AI processing unit outputs a probability distribution for each behavior category as output data. The present probability distribution is a set of numerical values such as a fall probability of 0.95, a walking probability of 0.02, and an immobility probability of 0.03, for example. The present generative AI processing unit outputs an abnormality score indicating a state of the care receiver as output data. The present abnormality score is a continuous value in a range of 0.0 to 1.0. The present generative AI processing unit outputs coordinate data of a bounding box indicating occurrence coordinates of the abnormality as output data. The present generative AI processing unit transmits these output results to the subsequent abnormality determination unit. The present abnormality determination unit determines whether or not the received abnormality score exceeds a preset threshold value. The present generative AI processing unit is pre-trained by combining supervised learning and self-supervised learning. The present generative AI processing unit uses a cross-entropy error and a contrastive learning loss as an error function. The present generative AI processing unit optimizes a weight parameter of the network using a gradient descent method. The present generative AI processing unit dynamically generates an individual model for each care receiver. The present generative AI processing unit receives activity history data of the past 30 days as an input, and generates a multidimensional cluster indicating an individual normal range. The present generative AI processing unit calculates how far a current state vector is from a normal cluster using a Mahalanobis distance. With this configuration, the present system realizes highly accurate abnormality detection exceeding a limit of visual monitoring by a human. The present system early discovers a minute physical condition change that is difficult to detect with a single sensor by integrating a plurality of sensor data. The present system exhibits a technical effect of dramatically reducing a false alarm rate. The present system is applied to a use case such as a night watch-over operation in a nursing care facility and remote monitoring in home nursing care.

The abnormality determination unit determines presence or absence of an abnormality and an urgency level based on an analysis result by the generative AI processing unit. For example, if there is a rapid decrease in a heart rate simultaneously with fall detection, it is determined as a serious accident, and immediate reporting to a medical institution is instructed. In a case of wandering or going out, notification with position information is sent to a family member or a staff terminal to prompt early discovery and response. In a case of forgetting to take medication or a mild physical condition change, a reminder or an alert is displayed on a care staff terminal. When wandering at night is detected, it is possible to immediately notify a watch-over staff in the facility and link with an alarm device at an entrance or an outer periphery. An abnormality during rehabilitation, an excretion abnormality, a meal abnormality, a bathing abnormality, a sleep disorder, and the like are also automatically determined according to an urgency level and a response priority, and a notification destination and a notification content are optimized. Specifically, the present abnormality determination unit is implemented as a hardware module including a dedicated microprocessor and a memory. The present abnormality determination unit receives a multidimensional abnormality score vector output from the generative AI processing unit as an input. The present abnormality score vector is an array of floating-point numbers including, for example, a fall risk score, a vital abnormality score, and a wandering risk score. The present abnormality determination unit applies a dynamic threshold determination algorithm to the input abnormality score vector. The present abnormality determination unit adjusts a threshold parameter in real time based on an individual profile of the care receiver. The present abnormality determination unit calculates a linear combination of a plurality of scores, and calculates a comprehensive urgency level index. The present urgency level index is output as a discrete integer value from level 1 to level 5, for example. The present abnormality determination unit generates an immediate reporting flag when the urgency level index is level 4 or higher. The present abnormality determination unit generates structured data including the urgency level index, an abnormality category label, and a response priority score as output data. The present structured data is transferred to the subsequent communication control unit. The present communication control unit selects a communication protocol based on the received structured data. The present abnormality determination unit combines a rule-based expert system and a machine learning-based classifier in a hybrid manner. The present classifier uses an algorithm such as a support vector machine and a random forest. The present abnormality determination unit periodically retrains the classifier using past incident data. With this configuration, the present system realizes objective and high-speed urgency level determination independent of human subjectivity. The present system exhibits a technical effect of suppressing an unnecessary alert and extracting only an event that truly requires urgency. The present system is applied to a use case such as a large-scale special nursing home for the elderly and a community comprehensive care center that simultaneously manages a plurality of home nursing care patients.

The communication control unit controls information transmission to a medical institution, a family member, a care staff terminal, an administrator terminal, and the like based on a determination result by the abnormality determination unit. For example, a name, an age, a current position, an abnormality content, an occurrence time, latest vital data, an activity history, image data, past illness information, allergy information, medication information, a name of a responding staff, a response start time, a rehabilitation history, an excretion history, a meal history, a bathing history, a sleep history, and the like of the care receiver are transmitted to the medical institution as an automatically generated report. An abnormality occurrence is notified to the family member in real time by a desired means such as a smartphone notification, an email, a voice call, an SNS notification, and an automatic response by a chatbot. An abnormality content and a recommended response measure for each care receiver are immediately notified to the care staff terminal and the administrator terminal to prompt a rapid on-site response. A notification content is automatically generated by the generative AI according to a situation, and a specific and individually optimized text is automatically generated, such as “A care receiver fell in a bathroom, and a heart rate decrease and a consciousness level change are detected. Implement an on-site response immediately”, “A care receiver wandered at night and reached near an entrance. Early discovery and response are recommended”, “A medication motion is not detected at a scheduled medication time, and there is a possibility of forgetting to take medication. Confirmation by a staff is recommended”, “An exercise amount rapidly decreased during rehabilitation, and a vital abnormality is detected. Contacting a person in charge of rehabilitation is recommended”, and “A meal amount rapidly decreased, and a body weight rapidly decreased. Consultation with a dietitian is recommended”. Specifically, the present communication control unit includes a network interface card and a dedicated communication control processor. The present communication control unit receives the structured data and the urgency level index output from the abnormality determination unit as an input. The present communication control unit dynamically selects an optimal communication path and communication protocol based on the input data. The present communication control unit automatically generates a natural language text for notification using a large language model. The present communication control unit supplies the abnormality category label, the numerical vector of the vital data, and a profile text of the care receiver to the large language model as input data. The present large language model is a neural network having hundreds of millions of parameters based on a transformer architecture. The present large language model generates a report text including a specialized medical term for a medical institution as output data. The present large language model generates a message text using a plain expression for a family member as output data. The present large language model generates an action plan text including a specific action instruction for a care staff as output data. The present communication control unit inputs the generated text data to an encryption module. The present encryption module encrypts data using an advanced encryption standard algorithm. The present communication control unit packetizes the encrypted data, and transmits it to an external network. The present communication control unit monitors a device state of a transmission destination, and executes retransmission processing until an arrival confirmation response is received. With this configuration, the present system completely automates optimal information transmission according to a situation. The present system exhibits a technical effect of minimizing a delay of information transmission in an emergency and optimizing communication traffic. The present system is applied to a use case such as prior information provision to a medical institution at the time of emergency transportation and rapid status sharing to an on-call staff in a nighttime zone.

The record management unit has a function of recording and managing an activity history, a health record, an abnormality occurrence history, a response history, a notification history, a family contact history, a medical institution cooperation history, a rehabilitation history, an excretion history, a meal history, a bathing history, a sleep history, a medication history, a fall history, a wandering history, a staff response history, an alert history, an environment information history (a room temperature, a humidity, an illuminance, a noise, an air quality, and the like), and the like for each care receiver in chronological order. For example, the number of past fevers and falls, a change in a sleep pattern, a transition of a meal amount, a change in the number of excretions, a staff response history, a contact content to a family member, a reporting content to a medical institution, a progress of rehabilitation, a medication status, a transition of a body weight, a body fat percentage, and a muscle mass, a transition of a blood pressure and a blood glucose level, a correlation between an environmental change and a health condition, and the like can be recorded in detail, and can be searched, extracted, and analyzed as necessary. The record management unit is also utilized as learning data of the generative AI, and can be useful for future risk prediction, preventive measure proposal, operation optimization, automatic generation of an individual care plan, automatic creation of an explanation material to a family member or a medical institution, inquiry response, automatic creation of a growth record, and the like. Specifically, the present record management unit includes a large-capacity solid state drive array and a distributed database management system. The present record management unit receives time-series data, an event log, and generated text data output from each module in the system as an input. The present record management unit converts the input data into a document format of a non-relational database. The present record management unit applies a data compression algorithm to the time-series data to save a storage capacity. The present record management unit constructs a multidimensional index in order to speed up data search. The present record management unit extracts a keyword and a topic from the accumulated text data using a natural language processing model. The present record management unit stores the extracted feature vector in a vector database. The present record management unit generates time-series graph data indicating an activity history of a designated period as output data. The present record management unit outputs a statistical matrix indicating an occurrence frequency of a specific abnormal pattern as output data. The present record management unit provides these output data in response to a query from the management terminal unit. The present record management unit guarantees data integrity using a blockchain technology or a hash chain technology in order to prevent data falsification. The present record management unit periodically replicates a data backup to a remote cloud storage. With this configuration, the present system safely and efficiently stores a huge amount of nursing care data for a long period of time. The present system exhibits a technical effect of dramatically improving a data search speed and supporting data-driven nursing care plan formulation. The present system is applied to a use case such as automatic generation of a periodic audit report to an administrative agency and provision of a monthly care report to a family member.

The management terminal unit is a terminal used by a care staff or an administrator, and has a function of receiving a notification from a server, a function of monitoring a state of a care receiver in real time, a function of instructing an additional response when an abnormality occurs, a browsing function of vital data and an activity history for each care receiver, a display function of a basis of abnormality determination by generative AI and a recommended response measure, a management function of a contact history to a family member, a management function of a cooperation history with a medical institution, an automatic generation function of a health record, an information sharing function among staffs, a visualization function of a behavior pattern and a health tendency, a rehabilitation progress management function, a history visualization function of excretion, a meal, bathing, sleep, medication, a fall, wandering, and the like, a monitoring function of environment information, an analysis function of an alert history, and the like. For example, a care staff carries a tablet terminal or a smartphone terminal, and can immediately confirm vital data, an activity history, an abnormality detection history, a rehabilitation progress, a meal, excretion, bathing, sleep, and medication history, environment information, an alert history, and the like for each care receiver. In addition, since a basis of abnormality determination by the generative AI and a recommended response measure are also displayed on the terminal, the staff can respond rapidly and accurately. For example, a specific response instruction is displayed, such as “A heart rate of a care receiver A is increased by 20% from normal. Hydration and rest are recommended”, “A care receiver B wandered at night and reached near an entrance. On-site confirmation by a staff is recommended”, and “A meal amount of a care receiver C rapidly decreased, and a body weight tends to decrease. Consultation with a dietitian is recommended”. Specifically, the present management terminal unit includes a high-resolution display, a touch panel interface, and a mobile processor for local processing. The present management terminal unit receives an encrypted data stream transmitted from a server side as an input. The present management terminal unit decrypts the input data stream on a local memory. The present management terminal unit dynamically renders a graphical user interface based on the decrypted data. The present management terminal unit incorporates an edge AI chip, and executes a part of inference processing locally. The present management terminal unit receives a voice command of a care staff and coordinate data of a touch operation as input data. The present management terminal unit converts the voice command into text data using a voice recognition model. The present management terminal unit generates a data acquisition request and a setting change command to the server as output data. The present management terminal unit generates a visual effect of an alert displayed on a screen and a drive signal of a vibration module as output data. The present management terminal unit maintains a bidirectional real-time communication session with the server. The present management terminal unit includes an offline mode of continuing to display latest data using a local cache even when a network connection is disconnected. With this configuration, the present system provides intuitive and delay-free information access to a care staff. The present system exhibits a technical effect of reducing a cognitive load of an on-site staff and supporting rapid decision making. The present system is applied to a use case such as a patrol operation in a geriatric health care facility having a vast site and a mobile information terminal of a visiting care staff.

Furthermore, the generative AI is also utilized for operation optimization of the entire facility. For example, it analyzes an activity pattern and a health condition tendency of a care receiver, and performs optimization proposal of a shift and an arrangement of a staff, notification of an accident frequent occurrence tendency in a specific time zone or place, automatic update of a monitoring standard and a notification content according to a change in growth or a health condition, automatic generation of a detailed explanation and advice in response to an inquiry from a family member, automatic optimization of a rehabilitation plan, automatic generation of a care plan such as a meal, excretion, bathing, sleep, medication, a fall, and wandering, response measure proposal to an environmental change, risk prediction and response measure proposal at the time of an infectious disease epidemic, evacuation guidance support at the time of a disaster, and the like. For example, when fall accidents frequently occur at night, the information can be notified to a staff or an administrator to prompt an alert or environment improvement in advance. It is also possible for the generative AI to automatically update a monitoring standard and a notification content according to a change in a health condition of a care receiver, and notify a staff or a family member. Specifically, the present generative AI includes a macro analysis module for integrally analyzing data of the entire facility. The present generative AI receives an anonymized activity history tensor of all care receivers, matrix data of a shift schedule of a staff, and a time-series array of an environment sensor in the facility as input data. The present generative AI models a complex interaction among a care receiver, a staff, and a facility environment using a graph neural network. The present generative AI searches for an optimal staff arrangement policy using a reinforcement learning algorithm. The present generative AI defines a current staff arrangement and a risk level of a care receiver as a state space, and defines a rearrangement command of a staff as an action space. The present generative AI sets a decrease in an incident occurrence rate and minimization of a moving distance of a staff as a reward function. The present generative AI generates a heat map image indicating an optimal staff arrangement in each time zone as output data. The present generative AI outputs a time-series probability vector indicating a predicted value of an accident occurrence probability as output data. The present generative AI generates structured text data indicating a change plan of a care plan as output data. The present generative AI transmits these output data to a terminal of an administrator, and automatically updates a setting of the system through an approval process. With this configuration, the present system optimizes facility operation that has depended on a rule of thumb in a data-driven manner. The present system exhibits a technical effect of maximizing arrangement efficiency of limited human resources and raising safety of the entire facility. The present system is applied to a use case such as a dynamic change of a zoning plan at the time of an infectious disease pandemic and optimization of air conditioning and personnel according to a seasonal variation.

As described above, the embodiment of the present invention organically links the image acquisition units, the biological information acquisition unit, the data aggregation unit, the generative AI processing unit, the abnormality determination unit, the communication control unit, the notification unit, the record management unit, and the management terminal unit, thereby highly watching over safety and health of a care receiver on a 24-hour basis, realizing a rapid and accurate response and information transmission when an abnormality occurs, and enabling realization of an advanced nursing care site independent of human resources, such as burden reduction of a care staff and improvement of a sense of security of a family member, optimization of facility operation, automatic generation of an individual care plan, future risk prediction and preventive measure proposal, inquiry response, and automatic creation of a growth record. Specifically, the present system adopts a distributed computing architecture that couples each component via a high-speed internal bus and a low-latency virtual private network. The present system maintains data consistency using a message queuing protocol while each unit operates asynchronously. The present system receives a continuous analog signal acquired from a physical space as a digitized multidimensional tensor as input data. The present system abstracts these tensors stepwise by pipeline processing, and converts them into semantic information. The present system generates an actuator signal for controlling a device in a physical space and a visual and auditory alert signal for prompting a human action as output data. The present system includes a self-diagnosis module that monitors an operation status of the entire system. The present self-diagnosis module constantly monitors a CPU usage rate, a memory consumption amount, and a network bandwidth of each unit, and executes load balancing that automatically eliminates a bottleneck. With this configuration, the present system constructs a cyber-physical system in which a physical space and a cyber space are highly fused, not limited to mere data collection and display. The present system realizes 24-hour, 365-day non-stop operation, and exhibits a technical effect of maximizing availability and fault tolerance of the system. The present system is applied to a use case as a core system of a smart hospital concept and a basic infrastructure of a next-generation fully automated nursing care facility.

### (System Configuration)

The system according to the present embodiment comprises image acquisition units, a biological information acquisition unit, a data aggregation unit, a generative AI processing unit, an abnormality determination unit, a communication control unit, a notification unit, a record management unit, and a management terminal unit. The image acquisition units are composed of a plurality of cameras and image sensors installed in all places where a care receiver daily moves and acts, such as a living room, a corridor, a bathroom, a toilet, a dining room, an entrance, a garden, stairs, in front of an elevator, an outdoor passage, a balcony, a common space, a rehabilitation room, a lounge, a washroom, a dressing room, a storage room, in front of a staff room, and near an emergency exit in a nursing care facility or a home nursing care site, and can acquire all activity statuses of the care receiver with high accuracy and in chronological order, such as walking in the corridor, a fall in the bathroom, a long stay in the toilet, an abnormal motion during a meal in the dining room, wandering in the living room, going out from the entrance, stumbling on the stairs, getting out of and returning to bed, deviation outside the facility, wandering at night, movement in a wheelchair, an exercise pattern during rehabilitation, a group activity in the lounge, a fall in the washroom, an unnatural motion in the dressing room, and a suspicious behavior near the emergency exit, for example, and flexibly respond to nighttime, a dark place, a blind spot, simultaneous monitoring of a plurality of persons, a privacy-conscious area, and the like by combining various sensors such as an infrared camera, a depth sensor, a wide-angle camera, a fisheye lens camera, a voice recognition microphone-integrated camera, and an AI-equipped camera. Specifically, the image acquisition units are composed of an intelligent camera group having an edge computing function. The image acquisition units receive, as input data, an intensity distribution of light imaged on an image sensor via a lens as an analog electrical signal. The image acquisition units convert the analog signal into a digitized image tensor using a built-in image processor. The image tensor is high-resolution data having, for example, 1920 horizontal pixels, 1080 vertical pixels, and three color channels. The image acquisition units integrate distance information obtained from the depth sensor to generate a 4-channel RGB-D tensor. The image acquisition units locally execute initial object detection and segmentation processing on the image tensor using an edge AI chip. The image acquisition units output, as output data, a keypoint vector indicating skeleton coordinates of the care receiver. The keypoint vector is, for example, a set of three-dimensional coordinates indicating joint positions of a human body. The image acquisition units output, as output data, a cropped image tensor in which a background region is deleted and only a person region is extracted. The image acquisition units compress these output data with a data compression algorithm and transmit the compressed data to the data aggregation unit. With this configuration, the system realizes privacy-conscious data collection while significantly reducing consumption of a network bandwidth. The system exerts a technical effect of minimizing a processing delay of the entire system by distributing a calculation load on a server side to an edge side. The system is applied to use cases such as silhouette extraction monitoring in a space where privacy protection is extremely important, such as a bathroom and a toilet, and infrared-based flow line analysis in a lights-out environment at night.

The biological information acquisition unit is composed of a wearable terminal worn by the care receiver or an environment-installed sensor, and an optimal terminal or sensor can be selected according to physical characteristics, a health condition, a lifestyle habit, a skin condition, presence or absence of allergies, presence or absence of dementia, presence or absence of a motor function disorder, a past illness, a medication status, and the like of the care receiver, such as a wristband-type terminal, a clothing-integrated sensor, a shoe-built-in sensor, a neck-hanging-type terminal, an ear-hanging-type terminal, a skin-attached sensor, a hearing aid-integrated sensor, an artificial leg/arm-built-in sensor, a bed mat sensor, a chair-built-in sensor, a toilet seat sensor, a waterproof sensor for bathing, a voice recognition microphone, an exhalation sensor, a weight scale-linked sensor, a blood pressure monitor-linked sensor, a blood glucose level sensor, and a body composition monitor-linked sensor, for example, and can acquire a wide variety of biological information in real time, such as a heart rate, a body temperature, a blood oxygen concentration, a respiratory rate, an activity amount, an acceleration, position information, an amount of sweating, a skin temperature, a skin potential, a body movement during sleep, fall detection, an immobility time, a number of steps, a posture, a voice, a motion during taking medication, a chewing/swallowing motion during a meal, a motion during excretion, a blood pressure, a blood glucose level, a body weight, a body fat percentage, a muscle mass, a bone density, a urine volume, a stool volume, a urination/defecation time, a body temperature change during bathing, a bathing time, a body movement during bathing, an exercise amount during rehabilitation, and a vital change during rehabilitation. Specifically, the biological information acquisition unit is implemented as a wearable device in which a microcontroller, various biological sensors, and a low-power-consumption wireless communication module are integrated. The biological information acquisition unit receives, as input data, analog signals of a minute potential change on a skin surface, an optical reflected light intensity indicating a volume change of a capillary blood vessel, and three-axis acceleration and angular velocity accompanying a body movement. The biological information acquisition unit converts these signals into discrete time-series numerical vectors using an analog-to-digital conversion circuit. The biological information acquisition unit executes bandpass filtering and baseline correction on the numerical vectors using a built-in digital signal processor. The biological information acquisition unit outputs, as output data, array data in milliseconds of a heartbeat interval from which noise has been removed. The biological information acquisition unit outputs, as output data, a quaternion array indicating an inclination of the device in a three-dimensional space. The biological information acquisition unit outputs, as output data, a vector of floating-point numbers indicating the skin temperature and the amount of sweating. The biological information acquisition unit packetizes these output data for each certain time window and transmits the packetized data to the data aggregation unit. The biological information acquisition unit dynamically changes a sampling rate of sensing according to an activity state of the care receiver in order to optimize battery consumption. With this configuration, the system continuously acquires medical-grade high-accuracy vital data without disturbing the daily life of the care receiver. The system exerts a technical effect of effectively removing motion artifacts and dramatically improving reliability of the data. The system is applied to use cases such as continuous nighttime monitoring for the purpose of early detection of sleep apnea syndrome and quantitative measurement of an exercise load during rehabilitation.

The data aggregation unit aggregates the data transmitted from the image acquisition units and the biological information acquisition unit in real time, stores daily activity histories and vital data for each care receiver in a time-series database, processes a large amount of data simultaneously transmitted from a plurality of care receivers at high speed and accurately, and also has a function of automatically correcting data loss or an abnormal value during a communication failure, and for example, even when data is temporarily interrupted due to a communication failure, can perform interpolation processing from preceding and succeeding data and provide the data as continuous data to the generative AI processing unit, and cooperates with a network infrastructure, a cloud server, an edge server, a local server, a data backup device, and the like of the entire facility to ensure safety, reliability, and scalability of the data. Specifically, the data aggregation unit is implemented as a high-performance edge server including a broadband network switch and an in-memory database. The data aggregation unit receives, as input data, data packets in various formats asynchronously transmitted from the image acquisition units and the biological information acquisition unit. The data aggregation unit analyzes header information of the input data packets and extracts a time stamp and a device ID. The data aggregation unit applies a resampling algorithm such as spline interpolation or linear interpolation in order to synchronize time-series data having different sampling rates. When a missing value is included, the data aggregation unit predicts and complements a numerical value of a missing part using a Kalman filter or an autoregressive moving average model. The data aggregation unit generates, as output data, a multidimensional integrated time-series tensor in which all modalities are aligned on the same time axis. The integrated time-series tensor has a structure in which vectors of several hundred dimensions including image feature amounts, vital data, and environmental data sampled at intervals of 1 second, for example, are continuous in a time direction. The data aggregation unit generates, as output data, a reliability score vector indicating quality of the data. The data aggregation unit transfers these output data to the generative AI processing unit via a high-speed internal bus. With this configuration, the system eliminates temporal inconsistency of heterogeneous mixed data and ensures inference accuracy in subsequent AI processing. The system exerts a technical effect of ensuring high robustness against network jitter and packet loss. The system is applied to use cases as a platform for centrally managing data traffic in a large-scale facility having hundreds of care receivers and integrating sensor devices of a plurality of different manufacturers.

The generative AI processing unit has a function of integrally analyzing the image data and the biological information data received from the data aggregation unit and automatically generating a normal range and a behavior pattern for each care receiver, and for example, uses image recognition AI to determine a walking pattern, a falling motion, a chewing or swallowing motion during a meal, a posture or motion during excretion, a body movement or breathing pattern during sleep, wandering or deviation outside the facility, a fall risk on stairs, a motion during taking medication, an abnormal behavior during bathing, an abnormal vocalization or a voice calling for help, an exercise pattern during rehabilitation, an abnormal motion during excretion, a change in a meal amount, a change in a water drinking amount, a change in a body weight, a body fat percentage, or a muscle mass, a sudden change in a blood pressure or a blood glucose level, an abnormality in a urine volume or a stool volume, a change in a urination/defecation time, an abnormality in a bathing time, a decrease in a body movement during bathing, a vital change during rehabilitation, and the like with high accuracy, learns a past activity history and vital data accumulated for each care receiver, automatically generates an individual normal range, and analyzes a plurality of abnormal patterns such as a falling motion, a wandering pattern, a sign of forgetting to take medication, a sudden physical condition change, long-time immobility, abnormal vocalization, an abnormality during rehabilitation, an excretion abnormality, a meal abnormality, a bathing abnormality, and a sleep disorder in real time to detect an abnormality. Specifically, the generative AI processing unit is implemented as a deep learning model running on a parallel computing cluster equipped with a plurality of GPUs. The generative AI processing unit receives, as input data, the multidimensional integrated time-series tensor output from the data aggregation unit. The generative AI processing unit adopts a hybrid architecture combining a temporal convolutional network and a gated recurrent unit in order to learn long-term dependencies of time-series data. The generative AI processing unit encodes the input tensor into a low-dimensional vector in a latent space. The generative AI processing unit constructs a probability distribution of a normal behavior pattern for each care receiver in the latent space using a mechanism of a variational autoencoder. The generative AI processing unit outputs, as output data, a reconstruction error score indicating a likelihood that current input data is generated from a normal probability distribution. The reconstruction error score is a continuous numerical value indicating a degree of abnormality. The generative AI processing unit outputs, as output data, a tensor of an attention map indicating a contribution degree of an input feature amount causing the abnormality. The generative AI processing unit outputs, as output data, a time-series prediction vector predicting a future transition of vital data. The generative AI processing unit continuously updates weights of the model using unsupervised learning, and automatically adapts to a drift of the normal range accompanying aging or a seasonal change of the care receiver. With this configuration, the system discovers an unknown abnormal pattern that cannot be captured by predefined rules in a data-driven manner. The system exerts a technical effect of dynamically generating a monitoring standard completely personalized to characteristics of an individual. The system is applied to use cases such as learning of a peculiar wandering pattern of a dementia patient and quantification of a progression degree of a minute motor disorder caused by a specific disease.

The abnormality determination unit determines presence or absence of an abnormality and an urgency level based on an analysis result by the generative AI processing unit, and for example, determines a serious accident if there is a sudden drop in a heart rate simultaneously with fall detection, instructs immediate reporting to a medical institution, notifies a family member or a staff terminal with position information in a case of wandering or going out to prompt early discovery and response, displays a reminder or a warning on a care staff terminal in a case of forgetting to take medication or a mild physical condition change, immediately notifies a watching staff member in the facility when nighttime wandering is detected, links with an alarm device at an entrance or an outer periphery, automatically determines an abnormality during rehabilitation, an excretion abnormality, a meal abnormality, a bathing abnormality, a sleep disorder, and the like according to an urgency level and a response priority, and optimizes a notification destination and a notification content. Specifically, the abnormality determination unit is implemented as a hybrid determination module integrating a rule engine and a machine learning-based inferencer. The abnormality determination unit receives, as input data, the reconstruction error score, the tensor of the attention map, and the prediction vector output from the generative AI processing unit. The abnormality determination unit applies an inference algorithm using fuzzy logic to the input data. The abnormality determination unit inputs a plurality of scores to a membership function and calculates a fitness for each abnormality category. The abnormality determination unit outputs, as output data, a normalized urgency level index from 0 to 100 indicating severity of the abnormality. The abnormality determination unit outputs, as output data, a one-hot vector of a classification label specifying a type of the abnormality. The abnormality determination unit generates, as output data, metadata including a list of feature amounts that are grounds for determination. When the urgency level index exceeds a predetermined threshold value, the abnormality determination unit generates a hardware interrupt to immediately activate subsequent processing. The abnormality determination unit receives a past false alarm history as feedback, and autonomously optimizes a determination threshold value using reinforcement learning. With this configuration, the system triages the urgency level with accuracy equal to or higher than that of a human expert even under a complex situation. The system exerts a technical effect of preventing fatigue of care staff called alert fatigue and minimizing a response time to a true crisis. The system is applied to use cases such as automatic triage under a situation with few staff members during a nighttime zone and dynamic determination of a response priority when a plurality of abnormalities occur simultaneously.

The communication control unit controls information transmission to a medical institution, a family member, a care staff terminal, an administrator terminal, and the like based on a determination result by the abnormality determination unit, and for example, transmits a name, an age, a current position, an abnormality content, an occurrence time, latest vital data, an activity history, image data, past illness information, allergy information, medication information, a name of a responding staff member, a response start time, a rehabilitation history, an excretion history, a meal history, a bathing history, a sleep history, and the like of the care receiver to the medical institution as an automatically generated report, notifies the family member of occurrence of the abnormality in real time by a desired means such as a smartphone notification, an email, a voice call, an SNS notification, or an automatic response by a chatbot, immediately notifies the care staff terminal or the administrator terminal of the abnormality content and a recommended response measure for each care receiver to prompt a prompt on-site response, and generative AI automatically generates a notification content according to a situation, and automatically generates a specific and individually optimized text such as, for example, “The care receiver fell in the bathroom, and a heart rate drop and a consciousness level change were detected. Implement an on-site response immediately.”, “The care receiver wandered at night and reached near the entrance. Early discovery and response are recommended.”, “A medication taking motion was not detected at a scheduled medication taking time, and there is a possibility of forgetting to take medication. Confirmation by staff is recommended.”, “An exercise amount rapidly decreased during rehabilitation, and a vital abnormality was detected. Contacting a person in charge of rehabilitation is recommended.”, or “A meal amount rapidly decreased, and a body weight rapidly decreased. Consultation with a nutritionist is recommended.” Specifically, the communication control unit functions as a gateway server implementing a plurality of communication protocol stacks. The communication control unit receives, as input data, the urgency level index, the one-hot vector of the classification label, and the metadata output from the abnormality determination unit. The communication control unit refers to a routing table based on the input data and determines an optimal destination endpoint. The communication control unit incorporates a dedicated text generation engine obtained by fine-tuning a large language model. The communication control unit supplies, as input data, a parameter group of the abnormality and context information of the care receiver as a prompt to the text generation engine. The text generation engine generates, as output data, a structured message in an HL7 format that can be directly imported into an electronic medical record system of the medical institution. The text generation engine generates, as output data, a JSON payload for push notification optimized for a smartphone of the family member. The text generation engine generates, as output data, an SSML markup text for synthesized voice for an intercom of the care staff. The communication control unit transmits the generated respective data in parallel via respective communication interfaces. The communication control unit constantly monitors quality of a communication path, and includes a mechanism for instantaneously failing over to a backup line when a failure occurs in a main line. With this configuration, the system distributes information optimized for each context to various stakeholders without delay. The system exerts a technical effect of eliminating a bottleneck of information transmission and dramatically accelerating an initial response in an emergency. The system is applied to use cases such as automatic transmission of a detailed vital history to an ambulance crew and real-time translation notification to a family member speaking multiple languages.

The notification unit has a function of transmitting information in an optimal format to each notification destination in accordance with an instruction from the communication control unit, transmits detailed health information to a medical institution in a format for electronic medical record cooperation, transmits a status explanation to a family member in easy-to-understand Japanese or multiple languages, notifies a care staff terminal by an alert sound or vibration when an immediate response is required, notifies an administrator terminal including statistical information and a past abnormality history, also includes an automatic generation function of a notification content, and generative AI automatically generates an optimal text, image, graph, voice message, or the like according to a situation and transmits it to each notification destination. Specifically, the notification unit is implemented as a client application and a background service running on each endpoint device. The notification unit receives, as input data, the JSON payload, the structured message, or the SSML markup text transmitted from the communication control unit. The notification unit analyzes the received data payload and executes UI rendering processing according to the urgency level index. When the urgency level is at a maximum level, the notification unit programmatically overrides a silent mode of the device and plays an alert sound at a maximum volume. The notification unit generates, as output data, a pixel matrix of a visual alert dialog displayed on a display. The notification unit drives a text-to-speech engine as output data, and outputs synthesized voice waveform data. The notification unit generates, as output data, an acknowledgment signal indicating that a user has confirmed the notification, and returns the signal to the server. The notification unit controls a haptic feedback module of a smartwatch to generate a specific pattern of vibration. With this configuration, the system reliably transmits information without depending on a situation of a receiver or a constraint of a device. The system exerts a technical effect of preventing oversight of information by a physical and software approach. The system is applied to use cases such as reliable notification to staff in a noisy dining room and a voice-based status report to a visually impaired family member.

The record management unit records and manages an activity history, a health record, an abnormality occurrence history, a response history, a notification history, a family contact history, a medical institution cooperation history, a rehabilitation history, an excretion history, a meal history, a bathing history, a sleep history, a medication history, a fall history, a wandering history, a staff response history, an alert history, an environmental information history, and the like for each care receiver in chronological order, records in detail a past number of fevers, a past number of falls, a change in a sleep pattern, a transition of a meal amount, a change in a number of excretions, a staff response history, a contact content to a family member, a reporting content to a medical institution, a progress of rehabilitation, a medication status, a transition of a body weight, a body fat percentage, and a muscle mass, a transition of a blood pressure and a blood glucose level, a correlation between an environmental change and a health condition, and the like, searches, extracts, and analyzes them as necessary, is also utilized as learning data for generative AI, and is useful for future risk prediction, preventive measure proposal, operation optimization, automatic generation of an individual care plan, automatic creation of an explanation material for a family member or a medical institution, inquiry response, automatic creation of a growth record, and the like. Specifically, the record management unit is implemented as a distributed file system and a time-series database cluster capable of processing petabyte-class data. The record management unit receives, as input data, a stream of all raw data, processing intermediate data, and event logs generated in the system. The record management unit stores the input data stream in a data lake using a schema-on-read architecture. For time-series data, the record management unit converts the data into a columnar format using a time stamp as a primary key and saves the data. The record management unit extracts an emotional polarity score and a vector of an important keyword from a response history text of staff using a natural language processing model. The record management unit generates, as output data, a JSON array including a list of past similar incidents matching a specified condition. The record management unit outputs, as output data, a multidimensional statistical matrix indicating a long-term trend of a health condition of the care receiver. The record management unit outputs, as output data, a tensor of a teacher data set formatted for retraining of a machine learning model. The record management unit automatically tiers old data to cold storage based on a data lifecycle management policy. With this configuration, the system utilizes a huge amount of history data not merely as a record but as a knowledge base for generating predictive insights. The system exerts a technical effect of reducing latency of data search and aggregation processing to milliseconds. The system is applied to use cases such as immediate presentation of evidence data in a regular review meeting of a care plan and data supply to a continuous integration pipeline of a machine learning model.

The management terminal unit is a terminal used by care staff or an administrator, and has a function of receiving a notification from a server, a function of monitoring a state of a care receiver in real time, a function of instructing an additional response when an abnormality occurs, a browsing function of vital data and an activity history for each care receiver, a display function of grounds for abnormality determination and a recommended response measure by generative AI, a management function of a contact history to a family member, a management function of a cooperation history with a medical institution, an automatic generation function of a health record, an information sharing function among staff, a visualization function of a behavior pattern and a health tendency, a rehabilitation progress management function, a history visualization function of excretion, a meal, bathing, sleep, medication, a fall, wandering, and the like, a monitoring function of environmental information, an analysis function of an alert history, and the like, and the care staff carries a tablet terminal or a smartphone terminal, can immediately confirm vital data, an activity history, an abnormality detection history, a rehabilitation progress, a meal, excretion, bathing, sleep, and medication history, environmental information, an alert history, and the like for each care receiver, and grounds for abnormality determination and a recommended response measure by generative AI are also displayed on the terminal, so that the staff can respond promptly and accurately. Specifically, the management terminal unit is implemented as a mobile device equipped with a secure execution environment and a dedicated dashboard application. The management terminal unit receives, as input data, a real-time vital data stream and a JSON object of an alert push-distributed from the server. The management terminal unit maps the input data onto a smooth time-series graph or a 3D facility map using a built-in graphics processing unit. The management terminal unit receives, as input data, coordinate trajectory data of a swipe or pinch-in/pinch-out by a user's touch screen operation. The management terminal unit generates, as output data, an API call requesting detailed data of a specific care receiver. The management terminal unit outputs, as output data, an array of Boolean values indicating feedback of staff to a recommended response measure presented by generative AI. The management terminal unit generates, as output data, an image tensor indicating an on-site situation photographed by a built-in camera, and uploads the image tensor to the server. The management terminal unit continuously verifies that an operator of the terminal is a staff member having legitimate authority using a biometric authentication module. With this configuration, the system converts a complex data group into visual information that can be intuitively understood, and dramatically reduces a cognitive load on staff. The system exerts a technical effect of seamlessly synchronizing an on-site situation and data in a cyber space. The system is applied to use cases such as efficient route guidance during a nighttime patrol and rapid situation recording and reporting at an abnormality occurrence site.

Specific examples of prompt sentences to be read by the generative AI when implementing the present invention include “Determine a fall risk and a sign of physical condition deterioration from changes in the number of times a care receiver gets out of bed at night and a walking speed, and generate an alert text for staff”, “When a falling motion and a heart rate drop in a bathroom are detected simultaneously, generate an emergency reporting text for a medical institution”, “When no motion is detected at a scheduled medication time, evaluate a possibility of forgetting to take medication, and generate a reminder text for a family member”, “Generate a review proposal text for a rehabilitation plan from an activity amount and a vital change during rehabilitation”, and “When a sudden decrease in a meal amount and a weight loss are detected simultaneously, generate a consultation recommendation text for a dietitian”. Specifically, the present system includes a prompt engineering module for controlling a large language model. The prompt engineering module receives structured data output from the abnormality determination unit, a profile vector of the care receiver, and current context information as input data. The prompt engineering module combines these input data to generate a dynamic prompt text to be an input to the large language model. The prompt text is a character string in a format including, for example, a role definition that you are a skilled nursing care support AI as a system prompt, including a care receiver ID and numerical values of the latest number of times of getting out of bed and the walking speed as input data, and including an instruction to evaluate a fall risk and generate a specific alert text for night staff within 100 characters as a task. The present system receives a natural language text stream generated from the large language model as output data. The present system calculates a reliability score for evaluating validity of the generated text as output data. The present system parses the generated text and filters whether an inappropriate expression or leakage of personal information is included. With this configuration, the present system realizes advanced natural language generation reflecting a subtle nuance of a situation without depending on a fixed template. The present system exerts a technical effect of improving specificity and persuasiveness of an instruction to the staff and preventing a human error. The present system is applied to use cases such as automatic generation of on-the-job training according to a situation for new staff and automatic reporting of a daily care status to a family member.

### (Implementation Steps)

### Step 1: Care Receiver Information and Terminal Registration

When a new care receiver starts using the system in a nursing care facility or a home nursing care site, detailed basic information such as a name, an age, a past illness, an allergy, an emergency contact, family information, a medication history, a rehabilitation plan, a lifestyle habit, and a physical characteristic is registered in the system from a management terminal unit, and an optimal wearable terminal or environment-installed sensor is assigned to each care receiver. Types of terminals are diverse, such as a wristband type, a clothing-integrated type, a shoe-built-in type, a skin-attached type, a bed mat type, a chair-built-in type, and a voice recognition microphone type, and a terminal ID and a care receiver ID are linked and registered in the system, an operation check and a communication test of the terminal are also executed, and it is confirmed that a data aggregation unit can normally receive data. Specifically, the present system executes a profile generation process for constructing a digital twin of the care receiver in an initial setting phase. The present system receives the basic information of the care receiver, text data of the past illness, and numerical data of the physical characteristic input from the management terminal unit as input data. The present system extracts a feature vector indicating a risk factor from the text data of the past illness using a natural language processing model. The present system receives a MAC address of the assigned wearable terminal and a calibration parameter of the sensor as input data. The present system generates a record of a relational database linking the care receiver ID and the terminal ID as output data. The present system transmits a control packet including an initialization command and a communication encryption key to the terminal as output data. The present system receives a response packet from the terminal and automatically executes a network diagnostic test for measuring a packet loss rate and a delay time. The present system dynamically sets an optimal sampling rate and buffer size for data transmission based on a diagnostic result. With this configuration, the present system automates a registration process of a new user and eliminates an artificial setting error. The present system exerts a technical effect of immediately constructing a sensing environment perfectly adapted to characteristics of each care receiver. The present system is applied to use cases such as a rapid acceptance process for a short-stay user and a smooth transition to home nursing care immediately after hospital discharge.

### Step 2: Real-Time Acquisition of Image and Biological Information

Image acquisition units are installed in various places inside and outside the facility, such as a living room, a corridor, a bathroom, a toilet, a dining room, a living room, an entrance, a garden, stairs, a rehabilitation room, a lounge, a washroom, a dressing room, and near an emergency exit, and acquire activity statuses such as walking, a fall, wandering, long-time immobility, eating and drinking, excretion, bathing, sleeping, waking up, going out, wheelchair movement, rehabilitation, group activity, and abnormal vocalization in chronological order. A biological information acquisition unit acquires a wide variety of biological information such as a heart rate, a body temperature, a blood oxygen concentration, a respiratory rate, an activity amount, an acceleration, position information, a sweating amount, a skin temperature, a skin potential, a body movement during sleep, fall detection, an immobility time, a number of steps, a posture, a voice, a motion during medication, a chewing/swallowing motion during a meal, a motion during excretion, a blood pressure, a blood glucose level, a body weight, a body fat percentage, a muscle mass, a bone density, a urine volume, a stool volume, a urination/defecation time, a body temperature change during bathing, and an exercise amount during rehabilitation in real time, and transmits the biological information to a data aggregation unit using Bluetooth, a wireless LAN, near field communication, a mobile phone line, or the like. Specifically, the present system executes a process of capturing a continuous data stream from a distributed sensor group in a data collection phase. The present system receives a video stream encoded in a high efficiency video coding format from a camera group of the image acquisition units as input data. The present system receives a payload of vital data transmitted from a wearable terminal of the biological information acquisition unit via a low power consumption wireless communication protocol as input data. The present system decodes the video stream and converts it into an image tensor for each frame at an edge gateway. The present system parses the payload of the vital data and extracts a numerical vector of the heart rate and the acceleration. The present system generates an annotated data object in which a highly accurate time stamp and spatial coordinate metadata are added to each data point as output data. The present system generates a transmission packet in which a data compression rate is dynamically adjusted according to a fluctuation of a network bandwidth as output data. The present system performs temporary buffering on an edge side to prevent data loss even in an environment where communication is unstable. With this configuration, the present system captures all events in a physical space as digital data without omission. The present system exerts a technical effect of stably supplying a high-quality and high-resolution data set essential for subsequent AI analysis. The present system is applied to use cases such as watching over without a blind spot in a special nursing home for the elderly having a vast site, and reliable data collection in home nursing care in a mountainous area where a communication infrastructure is fragile.

### Step 3: Data Aggregation and Chronological Management

The data aggregation unit aggregates a large amount of data transmitted from the image acquisition units and the biological information acquisition unit in real time, and stores a daily activity history and vital data for each care receiver in a time-series database. The data aggregation unit processes data transmitted simultaneously from a plurality of care receivers at high speed and accurately, and automatically corrects data loss or an abnormal value at the time of a communication failure. For example, even when data is temporarily interrupted due to a communication failure, interpolation processing is performed from preceding and succeeding data, and the data is provided to a generative AI processing unit as continuous data. Specifically, the present system executes a process of mapping an asynchronous and heterogeneous data stream to a single time-series space in a data integration phase. The present system receives the stream of the annotated data object generated in Step 2 as input data. The present system processes the input data in real time using an in-memory stream processing engine. The present system applies a dynamic time warping algorithm to align data from different sensors on a time axis. The present system applies an abnormality detection filter using an isolation forest algorithm to detect an outlier or spike noise included in the input data. The present system generates a multidimensional integrated time-series tensor from which noise is removed and which is temporally synchronized as output data. The present system outputs a vector of interpolation data generated using Gaussian process regression for a missing section of data as output data. The present system persists the generated integrated time-series tensor in a time-series database capable of high-speed reading and writing. Simultaneously with writing the data, the present system performs direct memory access transfer of the latest data window to a memory space of the generative AI processing unit. With this configuration, the present system prevents siloing of a huge amount of sensor data and establishes an integrated analysis platform. The present system exerts a technical effect of suppressing a data processing delay to a millisecond order and enabling real-time abnormality detection. The present system is applied to use cases such as monitoring of a complex vital fluctuation of a care receiver having a plurality of concurrent diseases, and correlation analysis between environmental data of the entire facility and personal health data.

### Step 4: Integrated Analysis and Individual Normal Range Generation by Generative AI

The generative AI processing unit integrally analyzes the image data and the biological information data received from the data aggregation unit, and automatically generates a normal range and a behavior pattern for each care receiver. For example, using image recognition AI, a walking pattern, a falling motion, a chewing or swallowing motion during a meal, a posture or motion during excretion, a body movement or breathing pattern during sleep, wandering or deviation outside the facility, a fall risk on stairs, a motion during medication, an abnormal behavior during bathing, an abnormal vocalization or a voice calling for help, an exercise pattern during rehabilitation, an abnormal motion during excretion, a change in a meal amount, a change in a water drinking amount, a change in a body weight, a body fat percentage, or a muscle mass, a sudden change in a blood pressure or a blood glucose level, an abnormality in a urine volume or a stool volume, a change in a urination or defecation time, an abnormality in a bathing time, a decrease in a body movement during bathing, a vital change during rehabilitation, and the like are determined with high accuracy, a past activity history and vital data accumulated for each care receiver are learned, an individual normal range is automatically generated, and a plurality of abnormal patterns such as a falling motion, a wandering pattern, a sign of forgetting to take medication, a sudden physical condition change, long-time immobility, abnormal vocalization, an abnormality during rehabilitation, an excretion abnormality, a meal abnormality, a bathing abnormality, and a sleep disorder are analyzed in real time to detect an abnormality. Specific examples of prompt sentences to be read by the generative AI include “Determine a fall risk and a sign of physical condition deterioration from changes in the number of times a care receiver gets out of bed at night and a walking speed, and generate an alert text for staff”, “When a falling motion and a heart rate drop in a bathroom are detected simultaneously, generate an emergency reporting text for a medical institution”,

“When no motion is detected at a scheduled medication time, evaluate a possibility of forgetting to take medication, and generate a reminder text for a family member”, “Generate a review proposal text for a rehabilitation plan from an activity amount and a vital change during rehabilitation”, and “When a sudden decrease in a meal amount and a weight loss are detected simultaneously, generate a consultation recommendation text for a dietitian”. Specifically, the generative AI processing unit adopts a multimodal transformer architecture. The processing unit receives a three-dimensional image tensor from the image acquisition units as an input. The image tensor has dimensions of a width, a height, and a color channel. The processing unit receives a one-dimensional time-series array from the biological information acquisition unit as an input. The time-series array includes numerical data such as a heart rate and a body temperature. The processing unit preprocesses these input data. The processing unit normalizes the image tensor. The processing unit interpolates a missing value of the time-series array. The processing unit converts the preprocessed data into a feature vector. The processing unit combines the feature vectors. The processing unit projects the combined vector into a high-dimensional space. The processing unit executes a clustering algorithm in the high-dimensional space. The processing unit calculates a boundary plane defining a normal range for each care receiver. The processing unit calculates a distance between a newly input data point and the boundary plane. The processing unit calculates an abnormality probability score based on this distance. The processing unit generates the abnormality probability score as output data. The processing unit transmits this output data to a subsequent abnormality determination unit. The model executes self-supervised learning using a large amount of normal data in advance. The model optimizes a feature representation using contrastive learning. The model updates a weight of a network by a backpropagation method. The present system realizes an objective judgment independent of a human empirical rule by this processing. The present system dramatically improves calculation efficiency of a computer. The present system reduces false detection. The present system reduces a memory usage amount. The present system is applied to a night monitoring task in a nursing care facility. The present system ensures safety of the care receiver. The processing unit includes a natural language processing model. The natural language processing model includes a self-attention mechanism. The model receives a prompt sentence as an input. The prompt sentence is expressed as an array of text tokens. The model receives a vector of vital data as a context. The model generates a response text based on these inputs. The model outputs an appearance probability distribution of words. The model sequentially selects a word with the highest probability. The processing unit transmits this generated text to a notification unit. The present system reduces a cognitive load on staff by this dynamic text generation. The present system realizes optimal information transmission according to a situation.

### Step 5: Abnormality Determination and Urgency Level Evaluation

The abnormality determination unit analyzes a plurality of abnormal patterns such as a sudden heart rate drop simultaneously with fall detection, wandering or going out, forgetting to take medication, a minor physical condition change, night wandering, an abnormality during rehabilitation, an excretion abnormality, a meal abnormality, a bathing abnormality, and a sleep disorder in real time based on an analysis result by the generative AI processing unit, and determines presence or absence of an abnormality and an urgency level. A notification destination and a notification content are optimized according to the urgency level and a response priority, and for example, in a case of a serious accident, immediate reporting to a medical institution is performed, in a case of wandering or going out, notification with position information to a family member or a staff terminal is performed, and in a case of forgetting to take medication or a minor physical condition change, a reminder or an alert to the staff terminal is performed. Specifically, the abnormality determination unit adopts a decision tree ensemble algorithm. The determination unit receives a vector of an abnormality probability score from the generative AI processing unit as an input. The vector includes a plurality of elements such as a fall probability and a wandering probability. The determination unit compares a value of each element with a plurality of preset thresholds. The determination unit executes a branching process based on this comparison result. The determination unit evaluates a synergistic effect when a plurality of abnormal patterns occur simultaneously. The determination unit calculates an urgency level label based on an evaluation result. The urgency level label is expressed as a numerical value. The determination unit generates this urgency level label as output data. The determination unit outputs a score of the response priority together with the urgency level label. The determination unit transmits this output data to a subsequent communication control unit. The determination unit acquires a past determination history from a database. The determination unit compares the past history with a current score. The determination unit detects a sudden change in a state by this comparison. The present system realizes rapid urgency level evaluation excluding human subjectivity by this processing. The present system minimizes a processing delay of a computer. The present system optimizes consumption of a network bandwidth. The present system supports appropriate allocation of limited medical resources. The present system is applied to early discovery of a serious accident. The present system accelerates an initial response of care staff. The determination unit executes principal component analysis for reducing the number of dimensions of input data. The determination unit reduces a calculation load. The determination unit ensures real-time performance. The determination unit temporarily stores an output result in a cache area on a memory. The determination unit omits recalculation of the same pattern using this cache. The present system improves a response speed of the entire system by this cache mechanism.

### Step 6: Automatic Notification and Information Transmission at Time of Abnormality

The communication control unit controls information transmission to a medical institution, a family member, a care staff terminal, an administrator terminal, and the like based on a determination result by the abnormality determination unit, and the notification unit transmits a name, an age, a current position, an abnormality content, an occurrence time, latest vital data, an activity history, image data, past illness information, allergy information, medication information, a name of responding staff, a response start time, a rehabilitation history, an excretion history, a meal history, a bathing history, a sleep history, and the like of the care receiver to the medical institution as an automatically generated report, notifies the family member of occurrence of an abnormality in real time by smartphone notification, an email, a voice call, SNS notification, an automatic response by a chatbot, or the like, and immediately notifies the care staff terminal or the administrator terminal of the abnormality content or a recommended response measure. A notification content is automatically generated by the generative AI according to a situation, and a specific and individually optimized text is automatically generated, such as “A care receiver fell in a bathroom, and a heart rate drop and a consciousness level change were detected. Implement an immediate on-site response”, “A care receiver wandered at night and reached near an entrance. Early discovery and response are recommended”, “A medication motion was not detected at a scheduled medication time, and there is a possibility of forgetting to take medication. Confirmation by staff is recommended”, “An exercise amount rapidly decreased during rehabilitation, and a vital abnormality was detected. Contacting a person in charge of rehabilitation is recommended”, and “A meal amount rapidly decreased, and a body weight rapidly decreased. Consultation with a dietitian is recommended”. Specifically, the communication control unit adopts an asynchronous communication protocol. The control unit receives an urgency level label and generated text data from the abnormality determination unit as an input. The control unit converts this input data into a structured payload. The payload is composed of a data format having a key-value pair. The control unit encrypts this payload using an encryption algorithm. The control unit transmits the encrypted data via a network interface. The notification unit identifies a type of a destination terminal. The notification unit converts a data format according to the type of the terminal. The notification unit generates a report including a detailed vital data array for the medical institution. The notification unit generates a concise text message for the family member. The notification unit transmits this generated message as output data. The notification unit receives a transmission completion status. The notification unit automatically executes a retransmission process when transmission fails. The present system guarantees reliable information transmission by this processing. The present system completely substitutes for a manual contact operation by a human. The present system prevents information loss due to a communication error. The present system realizes secure data transfer. The present system protects privacy information. The present system is applied to a simultaneous notification task to a plurality of related parties. The present system strengthens cooperation in an emergency. The control unit constructs a transmission queue on a memory. The control unit dynamically changes a priority of the queue based on the urgency level label. The control unit transmits data with a high priority first. The present system causes an important alert to arrive without delay even at the time of network congestion by this priority control. The present system improves availability of the entire system.

### Step 7: Response and Recording by Staff, Family Member, and Medical Institution

A related party who has received a notification using a management terminal unit, a family terminal, or a medical institution terminal implements an on-site response, and performs, for example, consciousness confirmation or first aid at the time of a fall, hydration or a rest instruction at the time of fever, rushing to a site or securing a care receiver at the time of wandering, medication confirmation or re-instruction at the time of forgetting to take medication, review of a rehabilitation plan at the time of a rehabilitation abnormality, consultation with a dietitian at the time of a meal abnormality, contact to a doctor at the time of an excretion abnormality, strengthening of bathing assistance at the time of a bathing abnormality, and review of a sleep environment at the time of a sleep disorder, a response content and progress are input from the management terminal unit to a record management unit, and an activity history, a health record, an abnormality occurrence history, a response history, a notification history, a family contact history, a medical institution cooperation history, a rehabilitation history, an excretion history, a meal history, a bathing history, a sleep history, a medication history, a fall history, a wandering history, a staff response history, an alert history, an environmental information history, and the like for each care receiver are recorded and managed in chronological order. Specifically, the record management unit adopts a distributed database system. The management unit receives text data of the response history from the terminal unit as an input. The management unit receives a time-series array of vital data from the biological information acquisition unit as an input. The management unit adds a time stamp to these input data. The management unit vectorizes the text data using a natural language processing model. The management unit stores this vector data as an index in a high-dimensional space. The management unit reduces a data size of the time-series array using a compression algorithm. The management unit writes this compressed data to a storage device as an output. The management unit receives a search query for the stored data. The management unit extracts related history data at high speed using vector similarity calculation. The management unit outputs this extracted data as a search result. The present system automates management of a huge amount of record data by this processing. The present system eliminates a recording omission due to a manual operation by a human. The present system dramatically improves a speed of data search. The present system optimizes utilization efficiency of a storage. The present system is applied to an audit response and a care plan creation task in a nursing care facility. The present system realizes evidence-based nursing care. The management unit periodically executes a data backup process. The management unit automatically migrates old data to a low-cost archive storage. The present system reduces an operation cost by this hierarchical storage management. The present system enables long-term data storage. The management unit applies a hash function for detecting data falsification. The present system guarantees data integrity.

### Step 8: Operation Optimization and Preventive Measure Proposal by Generative AI

Based on data accumulated in the record management unit, the generative AI processing unit automatically implements operation optimization of the entire facility, future risk prediction, preventive measure proposal, automatic generation of an individual care plan, automatic creation of an explanatory material for a family member or a medical institution, inquiry response, automatic creation of a growth record, and the like. For example, an activity pattern and a health condition tendency of a care receiver are analyzed, and an optimization proposal for a shift or arrangement of staff, notification of an accident frequent occurrence tendency in a specific time zone or place, automatic update of a monitoring standard or a notification content according to a change in growth or a health condition, automatic generation of a detailed explanation or advice for an inquiry from a family member, automatic optimization of a rehabilitation plan, automatic generation of a care plan for a meal, excretion, bathing, sleep, medication, a fall, wandering, and the like, proposal of a response measure to an environmental change, risk prediction and response measure proposal at the time of an infectious disease epidemic, evacuation guidance support at the time of a disaster, and the like are performed. Specific examples of prompt sentences to be read by the generative AI include “Propose a risk prediction and a preventive measure for the next one month from a fall occurrence tendency of all care receivers in the past one year”, “Generate an instruction text for automatically updating a monitoring standard and a notification content according to a change in a health condition of a care receiver”, “Generate an optimization plan for a next rehabilitation plan from a rehabilitation history and vital data”, and “Generate a review proposal text for a nutrition management plan from a transition of a meal amount, a body weight, and a nutritional state”. Specifically, the generative AI processing unit adopts a deep reinforcement learning algorithm. The processing unit receives a multidimensional time-series database accumulated from the record management unit as an input. The database includes a past abnormality occurrence history and a staff response history. The processing unit groups this input data using a clustering algorithm. The processing unit extracts a feature of each group. The processing unit calculates a future abnormality occurrence probability using a time-series prediction model. The processing unit outputs this prediction probability as a numerical vector. The processing unit calculates an optimal staff arrangement parameter based on this prediction result. The processing unit generates this parameter as an optimization proposal text. The processing unit transmits this text to an administrator terminal as output data. The model calculates an error between a past prediction result and an actual result. The model automatically updates an internal parameter so as to minimize this error. The present system realizes data-driven operation optimization independent of an empirical rule by this processing. The present system supports a plan formulation task by a human administrator. The present system proactively reduces a risk of the entire facility. The present system levels a load of the entire system by concentrating calculation resources of a computer on prediction processing. The present system is applied to management improvement and a resource management task of a nursing care facility. The present system improves quality of a service. The processing unit automatically creates an explanatory material for a family member using a natural language generation model. The processing unit executes a process of replacing a technical term with a general vocabulary. The present system prevents a communication discrepancy by this automatic translation function. The present system significantly reduces an office work time of staff.

### (Specific Use Case)

For example, assume a case where a care receiver gets out of bed at night in a nursing care facility and walks down a corridor to a toilet. The image acquisition units acquire a bed-leaving motion and a walking pattern in chronological order by cameras installed in a living room and the corridor, and the biological information acquisition unit acquires vital data such as a heart rate, a body temperature, an acceleration, a number of steps, a posture, and position information in real time from a wearable terminal. A data aggregation unit immediately aggregates these data, and the generative AI processing unit integrally analyzes the image data and the vital data. The generative AI learns a history of a walking speed, a stride length, a fall risk index, a heart rate fluctuation, a body temperature change, a walking distance, a toilet stay time, and the like at the time of past night bed-leaving for each care receiver, and automatically generates an individual normal range. In this case, it is detected that the walking speed is significantly lower than usual, the stride length is narrowed, staggering is detected by an acceleration sensor, and the heart rate also exceeds a reference value. The generative AI determines to the abnormality determination unit that “simultaneous occurrence of a walking speed decrease, staggering, and a heart rate increase at the time of night bed-leaving is highly likely to be a sign of a fall risk or poor physical condition”. The abnormality determination unit evaluates an urgency level, and transmits a notification instructing the care staff terminal to perform immediate on-site confirmation. The notification unit displays “A walking speed decrease, staggering, and a heart rate increase are detected at the time of night bed-leaving of the care receiver.

Perform on-site confirmation immediately” on the care staff terminal, and simultaneously displays a comparison graph with past night bed-leaving data and grounds for abnormality detection on a management terminal unit. A care staff member confirms the physical condition of the care receiver on site, and performs body temperature measurement and contact to a medical institution as necessary. An abnormality detection time, vital data, on-site response contents, and a staff response history are automatically recorded in the record management unit. Specifically, the image acquisition units adopt a camera device including an infrared sensor. The acquisition units acquire a two-dimensional infrared image tensor as input data in a low-illuminance environment. The biological information acquisition unit adopts a wearable device including a three-axis acceleration sensor. The acquisition unit acquires a three-dimensional acceleration vector as input data. The data aggregation unit synchronizes these heterogeneous data on the same timeline. The generative AI processing unit executes a posture estimation neural network. The processing unit extracts skeletal coordinates of a human body from the image tensor. The processing unit calculates numerical values of the walking speed and the stride length from a chronological change of the skeletal coordinates. The processing unit analyzes a frequency component from the acceleration vector. The processing unit digitizes a degree of staggering from the frequency component. The processing unit combines these numerical values to generate a feature vector. The processing unit calculates a Mahalanobis distance between the feature vector and a boundary of the normal range learned in advance. The processing unit outputs an abnormality flag when the distance exceeds a predetermined threshold. The abnormality determination unit receives the abnormality flag. The determination unit sets an urgency score to a highest level. The notification unit generates an alert signal based on the urgency score. The notification unit immediately transmits the alert signal to the staff terminal. The system overcomes a limit of human visual monitoring in a dark place by this processing. The system dramatically reduces false alarms by sensor fusion technology. The system maximizes image processing capability of a computer. The system is applied to prevention of a fall accident at night. The system ensures safety of the care receiver. The processing unit temporarily processes a calculation result on a local edge device. The system eliminates a communication delay to a cloud by this edge computing. The system maximizes real-time performance.

Further, for example, when a chewing motion stops while the care receiver is eating in a dining room and a sudden movement is detected by the acceleration sensor, the image acquisition units capture the chewing stop and an unnatural posture from a camera video of the dining room, and the biological information acquisition unit acquires a rapid increase in the heart rate and a change in a respiratory rate. The generative AI processing unit integrally analyzes the image data and the vital data, and determines that “a chewing stop and a rapid heart rate increase during a meal have a high risk of aspiration or choking”. The abnormality determination unit sets the urgency level to a highest level, and transmits an immediate emergency notification to a medical institution and a family member via the communication control unit. The notification unit transmits an automatically generated report stating “The care receiver showed a chewing stop and a rapid heart rate increase during a meal, and choking is suspected. A current position is the dining room, a responding staff name, latest vital data, and image data are attached” to the medical institution, and transmits a status explanation text stating “An abnormality is detected while the care receiver is eating. A staff member is currently responding, and the medical institution has also been contacted” to the family member. An alert stating “Choking risk detected. Perform immediate response” is displayed on the care staff terminal. All data from occurrence of the abnormality to completion of the response are recorded in chronological order in the record management unit. Specifically, the image acquisition units adopt a high-resolution camera device. The acquisition units acquire a continuous image tensor including a face region of the care receiver as input data. The biological information acquisition unit adopts an optical heart rate sensor. The acquisition unit acquires a chronological array of the heart rate as input data. The generative AI processing unit executes a convolutional neural network. The processing unit extracts a minute movement of a mouth from the image tensor as a feature map. The processing unit executes a recurrent neural network. The processing unit analyzes a chronological change of the feature map. The processing unit detects a stop of the chewing motion by this analysis. The processing unit detects a rapid rising trend from the chronological array of the heart rate. The processing unit integrates these detection results. The processing unit calculates an aspiration probability score. The processing unit determines an emergency situation when the score exceeds a safety threshold. The abnormality determination unit receives the determination result. The determination unit sets an urgency label to the highest level. The communication control unit generates a data package for the medical institution based on the urgency label. The package includes the latest image tensor and an array of the vital data. The control unit transmits the package as output data to an external application programming interface. The system instantaneously captures a minute biological change that is easily overlooked by human observation by this processing. The system realizes highly accurate state monitoring without contact. The system improves an analysis speed by parallelization of data processing. The system is applied to prevention of a choking accident during a meal. The system improves a lifesaving rate. The processing unit executes filtering processing for removing background noise. The system improves recognition accuracy by this preprocessing.

Furthermore, for example, when the care receiver falls while bathing in a bathroom, a large impact is detected by the acceleration sensor, and the image acquisition units capture a falling motion, the biological information acquisition unit acquires a heart rate decrease and a change in a consciousness level immediately after the fall. The generative AI processing unit integrally analyzes the falling motion and a sudden change in the vital data, and determines that “a risk of a head injury or a consciousness disorder due to the fall is high”. The abnormality determination unit sets the urgency level high, and performs simultaneous notification to the medical institution, the family member, and the care staff terminal via the communication control unit. The notification unit transmits an automatically generated report stating “The care receiver fell in the bathroom, and a heart rate decrease and a consciousness level change are detected. A current position is the bathroom, a responding staff name, latest vital data, and image data are attached” to the medical institution, and transmits a status explanation text stating “The care receiver fell in the bathroom, and a staff member is currently responding. The medical institution has also been contacted” to the family member.

An alert stating “Severe risk due to fall detected. Perform immediate on-site response” is displayed on the care staff terminal. All data from occurrence of the abnormality to completion of the response are recorded in detail in the record management unit. Specifically, the image acquisition units adopt a depth sensor for the purpose of privacy protection. The acquisition units acquire three-dimensional point cloud data of an object as input data. The biological information acquisition unit adopts a completely waterproof wearable device. The acquisition unit acquires a chronological array of the heart rate and a blood oxygen concentration as input data. The generative AI processing unit executes a three-dimensional convolutional neural network. The processing unit extracts a spatial feature vector from the point cloud data. The processing unit detects a rapid change in height from the feature vector. The processing unit classifies the change as a falling motion. The processing unit detects a rapid decrease in the heart rate from the chronological array of the vital data. The processing unit integrates these classification results and detection results. The processing unit calculates a severity score. The processing unit generates the severity score as output data. The abnormality determination unit receives the severity score. The determination unit activates a simultaneous transmission process to a plurality of notification destinations based on the score. The notification unit generates a structured incident report for the medical institution. The notification unit transmits the report as output data. The system realizes highly accurate abnormality detection without invading privacy by this processing. The system ensures safety in a closed space where human monitoring is difficult. The system uses a hardware accelerator specialized for processing point cloud data. The system reduces a calculation load. The system is applied to early discovery of a serious accident in the bathroom. The system supports a rapid emergency response. The processing unit executes an algorithm for removing sensor noise due to water vapor or water droplets. The system prevents false detection by this noise removal. The system guarantees stable operation even in a harsh environment.

Specific examples of a prompt sentence to be read by the generative AI include “When a walking speed, staggering, and a heart rate increase at the time of night bed-leaving of a care receiver occur simultaneously, compare with past night bed-leaving data, and determine presence or absence of a fall risk or physical condition deterioration and a recommended response measure”, “When a chewing stop and a rapid heart rate increase during a meal are detected, evaluate presence or absence of a choking risk, and generate an emergency reporting text for a medical institution”, “When a falling motion and a heart rate decrease in a bathroom are detected simultaneously, evaluate a head injury risk, and generate a status explanation text for a family member”, “When an activity amount decrease and a vital abnormality during rehabilitation are detected simultaneously, generate a review proposal text for a rehabilitation plan”, and “When a rapid decrease in a meal amount and a weight loss are detected simultaneously, generate a consultation recommendation text for a dietitian”. Specifically, the generative AI processing unit adopts a large language model. The model is composed of a transformer architecture including a self-attention mechanism. The processing unit receives a prompt sentence described in natural language as input data. The processing unit simultaneously receives vital data and past history data of the care receiver as a numerical vector. The processing unit converts the numerical vector into a text token. The processing unit combines a token of the prompt sentence and the converted token. The processing unit inputs the combined token array to the model. The model calculates a dependency relationship between tokens using billions of parameters. The model predicts a word token having a highest probability of appearing next. The model generates a series of text data by repeating the prediction. The processing unit provides the generated text data as an output. The processing unit transmits the output text to the notification unit. The model is fine-tuned in advance using a large amount of text data in medical and nursing care domains. The model acquires an ability to understand a specialized context. The system realizes flexible text generation suitable for a situation that is not a fixed phrase by this processing. The system saves time and effort for a human staff member to manually create a report. The system improves accuracy and speed of information transmission. The system directly integrates natural language processing capability of a computer into a business flow. The system is applied to communication support in a nursing care site. The system facilitates information sharing among staff members. The processing unit applies a parameter for limiting a length of the generated text. The system guarantees a readable and concise message by this control.

In this way, the system of the present invention automatically collects and analyzes activity statuses and biological information of a care receiver from multiple angles and in real time, determines presence or absence of an abnormality and an urgency level with high accuracy using generative AI, and automatically generates and transmits an optimal notification text and response instruction to a medical institution, a family member, a care staff terminal, and the like when an abnormality occurs, thereby making it possible to dramatically improve safety and efficiency of a nursing care site. Specifically, the system adopts a distributed processing architecture in which an edge device and a cloud server cooperate. The system preprocesses multidimensional sensor data acquired on a terminal side in real time. The system compresses a data size by this preprocessing. The system transmits the compressed data to a parallel computing cluster on a cloud side. The cluster executes a deep learning model at high speed using a plurality of computing units. The system immediately feeds back an inference result to an edge side. The system automatically controls the series of data pipelines. The system constructs a completely autonomous monitoring loop that does not require human intervention. The system solves a complex event that cannot be handled by a conventional rule-based system by artificial intelligence. The system improves processing capability and responsiveness of computer technology itself. The system minimizes consumption of a network bandwidth. The system improves availability and scalability of the entire system. The system is applied to a wide range of environments from a small-scale facility to a large-scale hospital. The system technically solves a social problem of a labor shortage in the entire nursing care industry. The system autonomously improves detection accuracy by continuous machine learning. The system automatically learns a new abnormal pattern. The system always maintains a latest monitoring model. The system includes a self-diagnosis function for detecting a hardware failure. The system automatically takes over processing to a spare node when a failure occurs. The system realizes non-stop operation by this redundancy.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

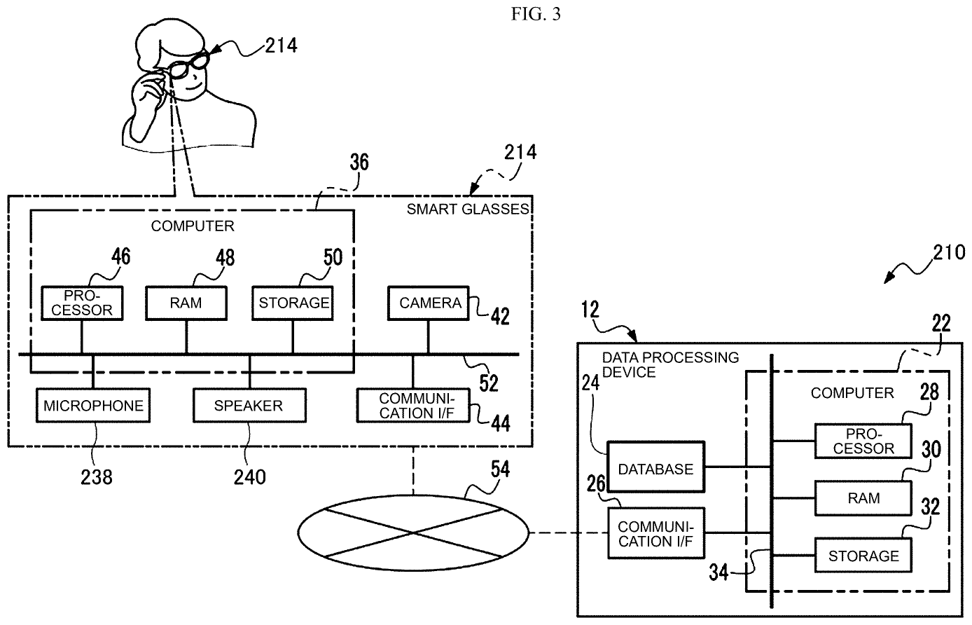

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

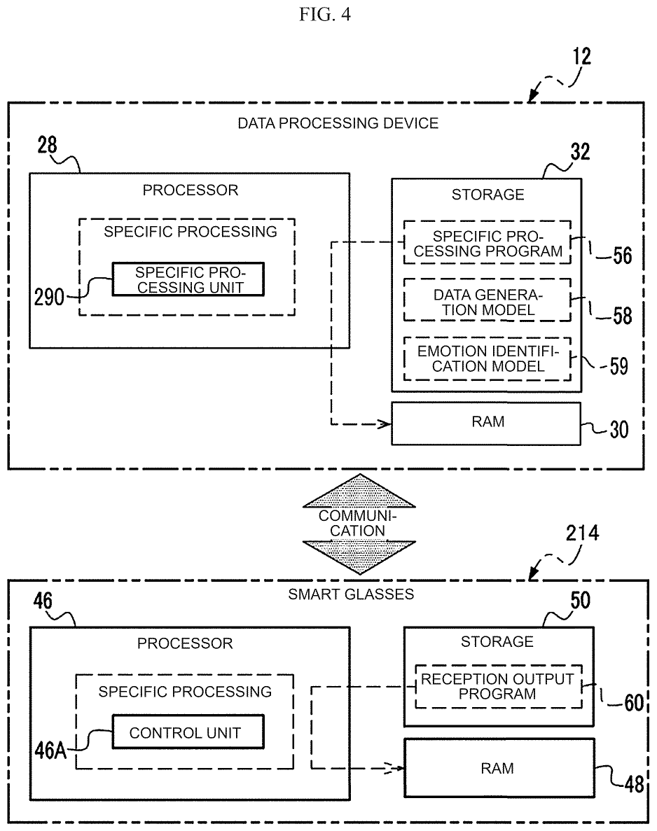

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### (Example 1)

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

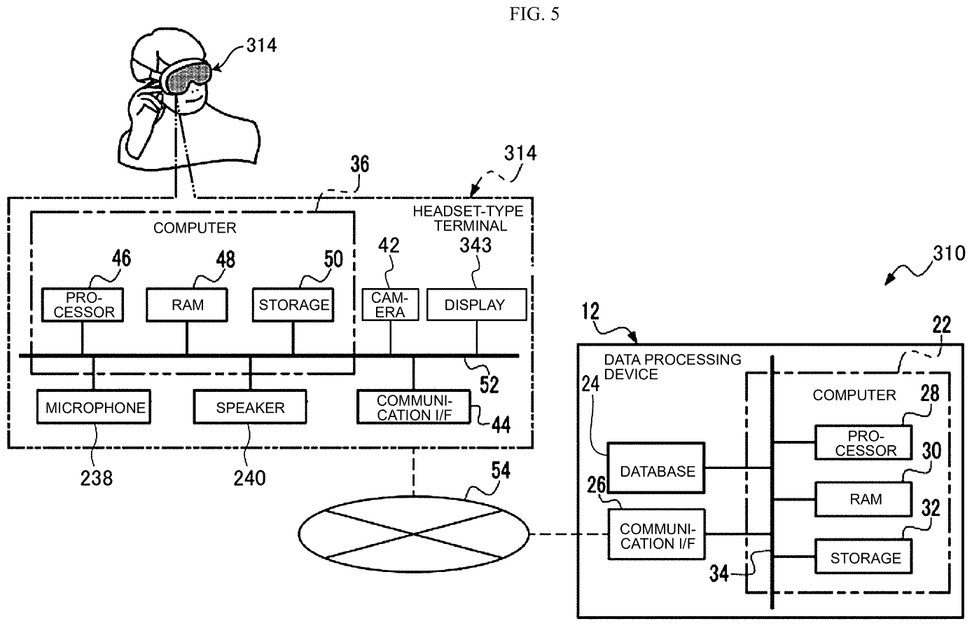

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

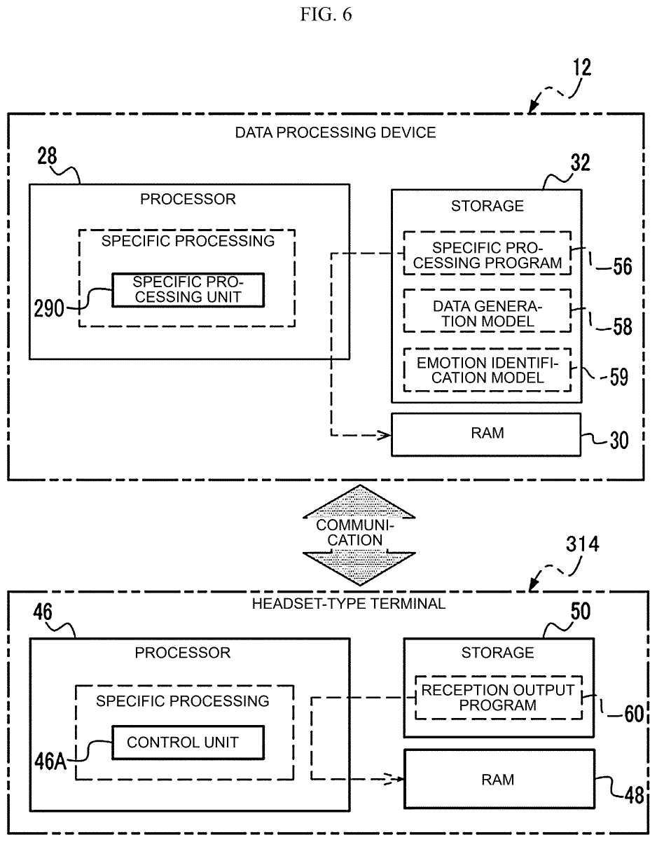

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

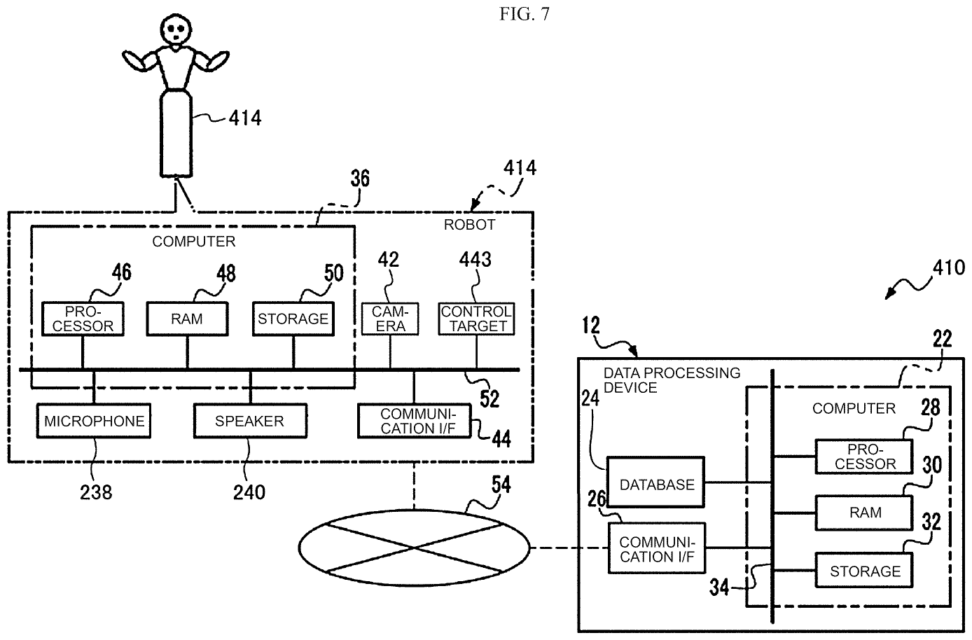

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

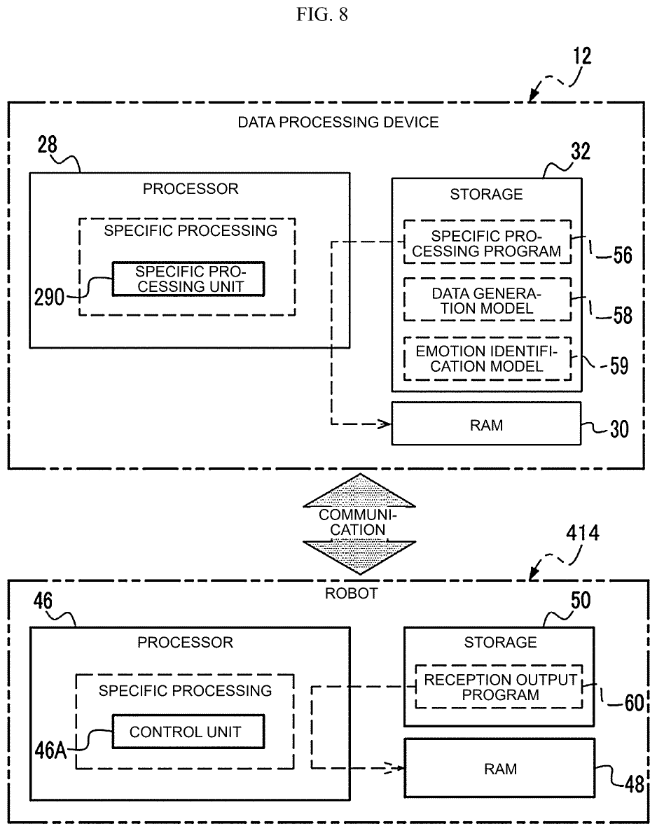

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

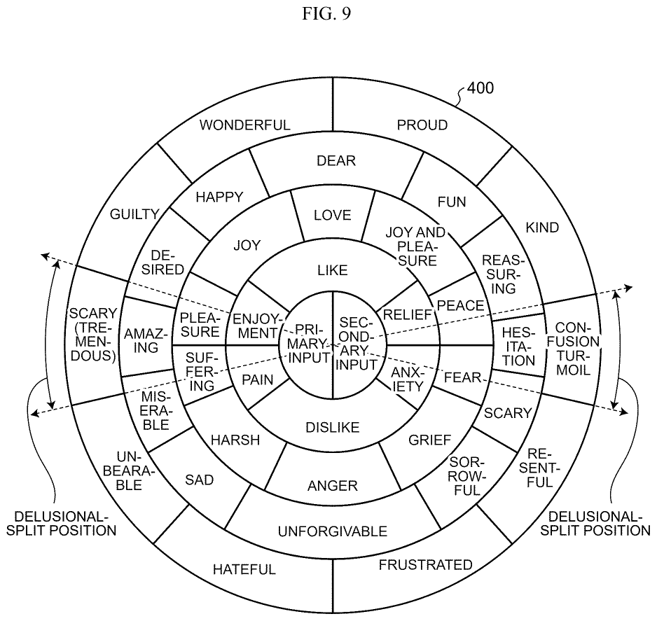

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

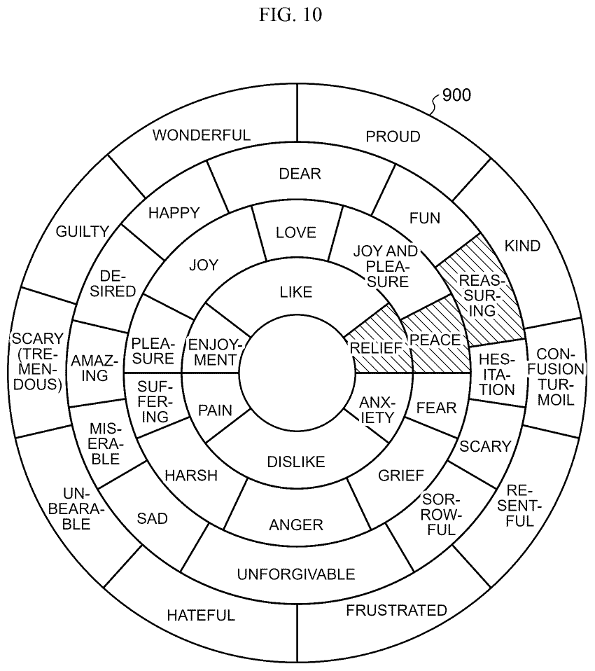

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### (Supplementary Note 1)

A system comprising: image acquisition units; a biological information acquisition unit; a generative AI processing unit; an abnormality determination unit; a communication control unit; and a notification unit, wherein the image acquisition units are composed of a plurality of cameras and image sensors installed in various places in a nursing care facility or a residence, and acquire activity statuses of a care receiver such as walking, a fall, wandering, long-time immobility, eating and drinking, excretion, bathing, sleeping, and waking up in chronological order, the biological information acquisition unit acquires a wide variety of biological information such as a heart rate, a body temperature, a blood oxygen concentration, a respiratory rate, an activity amount, an acceleration, position information, a body movement during sleep, fall detection, an immobility time, a number of steps, a posture, and a voice in real time by a wearable terminal worn by the care receiver, the generative AI processing unit integrally analyzes data acquired from the image acquisition units and the biological information acquisition unit to automatically generate a normal range and a behavior pattern for each care receiver, the abnormality determination unit determines presence or absence of an abnormality such as a fall, wandering, a sudden change, physical condition deterioration, forgetting to take medication, and a sleep disorder, and an urgency level based on an analysis result by the generative AI processing unit, the communication control unit controls information transmission to a medical institution, a family member, a care staff terminal, an administrator terminal, and the like according to a determination result by the abnormality determination unit, and the notification unit transmits information in an optimal format to each notification destination in accordance with an instruction from the communication control unit, and essentially uses generative AI also in automatic generation of a notification content.

### (Supplementary Note 2)

The system according to Supplementary Note 1, wherein the generative AI processing unit learns a past activity history and vital data accumulated for each care receiver, and automatically generates an individual normal range and an abnormal pattern, the abnormality determination unit analyzes a plurality of abnormal patterns such as a falling motion, a wandering pattern, a sign of forgetting to take medication, a sudden physical condition change, long-time immobility, and abnormal vocalization in real time to detect an abnormality, and the communication control unit and the notification unit automatically optimize a notification content and a notification destination to a medical institution, a family member, a care staff terminal, an administrator terminal, and the like according to an abnormality content and an urgency level.

### (Supplementary Note 3)

The system according to Supplementary Note 1, further comprising a record management unit, wherein the record management unit records and manages an activity history, a health record, an abnormality occurrence history, a response history, a notification history, a guardian contact history, a medical institution cooperation history, and the like for each care receiver in chronological order, and the generative AI processing unit realizes future risk prediction, operation optimization, preventive measure proposal, inquiry response, automatic creation of a growth record, and the like using data accumulated in the record management unit.

What is claimed is:

1. A system comprising:
circuitry configured to:
receive, via a communication interface coupled to a packet-switched network, video stream data from a plurality of imaging devices and physiological parameter data from wearable monitoring devices associated with a monitored entity, and process the video stream data at an edge server by applying real-time masking to image regions designated as privacy-sensitive areas to generate a silhouette data stream while discarding original image data;
transmit the silhouette data stream and the physiological parameter data to a cloud computing node via the communication interface, apply a generative neural network model to the silhouette data stream to generate activity state classification labels, and apply a biosensor analysis model to the physiological parameter data to compute physiological deviation scores;
apply an integrated anomaly detection model to the activity state classification labels and the physiological deviation scores to generate an anomaly determination record when an anomaly threshold parameter is exceeded; and
transmit the anomaly determination record and an alert notification to terminal devices via the communication interface, and issue an emergency contact command to an emergency response service endpoint when an anomaly severity score exceeds an emergency threshold parameter.

2. The system according to claim 1, wherein the circuitry is configured to apply a silhouette extraction algorithm at the edge server to each video frame by computing a background subtraction model to isolate foreground person regions, generating a binary silhouette mask, and discarding all pixel-level color and texture information from the masked region prior to transmission to the cloud computing node.

3. The system according to claim 2, wherein the circuitry is configured to apply a pose estimation model to the silhouette data stream to extract skeletal joint coordinate sequences, compute motion parameter vectors comprising velocity, acceleration, and joint angle change rates from the skeletal joint coordinate sequences, and incorporate the motion parameter vectors as input features to the generative neural network model.

4. The system according to claim 3, wherein the circuitry is configured to apply a fall detection model to the motion parameter vectors by comparing a rapid vertical joint coordinate displacement event against a fall signature pattern template, generate a fall detection signal when the displacement event matches the fall signature pattern template with a confidence score exceeding a fall detection threshold, and incorporate the fall detection signal in the anomaly determination record.

5. The system according to claim 1, wherein the circuitry is configured to receive the physiological parameter data from wearable monitoring devices comprising heart rate values, body temperature values, blood oxygen concentration values, and activity level values at a predetermined sampling rate via the communication interface, apply a low-pass filter to each physiological parameter time-series to remove high-frequency noise, and compute physiological deviation scores by comparing filtered values against individual baseline parameter ranges stored in the storage device.

6. The system according to claim 5, wherein the circuitry is configured to apply a multivariate anomaly detection model to a combined feature vector comprising the motion parameter vectors and the physiological deviation scores, compute a joint anomaly probability score, and generate the anomaly determination record when the joint anomaly probability score exceeds the anomaly threshold parameter.

7. The system according to claim 1, wherein the circuitry is configured to apply a longitudinal monitoring model to chronological sequences of activity state classification labels and physiological parameter values stored in the storage device to detect gradual state deterioration patterns, generate a deterioration trend indicator when a sustained negative trend is detected, and incorporate the deterioration trend indicator in a progress report data record for transmission to terminal devices.

8. The system according to claim 1, wherein the circuitry is configured to receive position tracking data from location sensor devices associated with the monitored entity via the communication interface, generate movement trajectory data from the position tracking data, and apply the integrated anomaly detection model to the movement trajectory data to detect prolonged inactivity events exceeding an inactivity threshold duration.

9. The system according to claim 8, wherein the circuitry is configured to generate the alert notification when a prolonged inactivity event is detected, transmit the alert notification to terminal devices associated with designated contact user identifiers, and escalate to the emergency contact command when the inactivity event duration exceeds an emergency escalation threshold.

10. The system according to claim 1, wherein the circuitry is configured to apply an automatic speech analysis model to audio stream data received from microphone devices at the monitored environment via the communication interface, compute a vocal pattern deviation score from the audio stream data, and incorporate the vocal pattern deviation score as an additional input feature in the integrated anomaly detection model.

11. The system according to claim 1, wherein the circuitry is configured to accumulate activity state classification labels, physiological parameter data, and anomaly determination records in a longitudinal monitoring record data structure in the storage device associated with the monitored entity identifier, and generate a periodic monitoring summary report for transmission to terminal devices associated with authorized contact user identifiers.

12. The system according to claim 1, wherein the circuitry is configured to apply the generative neural network model to the anomaly determination record and historical resolution records retrieved from a vector database by cosine similarity search to generate a recommended care action sequence, and transmit the recommended care action sequence to terminal devices associated with care staff user identifiers.

13. The system according to claim 1, wherein the circuitry is configured to apply a distributed monitoring network architecture by linking multiple edge servers at local area network segments with the cloud computing node via a wide area network, execute privacy masking processing independently at each edge server, and aggregate processed data streams from all edge servers at the cloud computing node for integrated analysis.

14. The system according to claim 1, wherein the circuitry is configured to enforce a privacy access control policy by restricting access to raw silhouette data streams and physiological parameter data to authorized user identifiers, and apply a data minimization policy returning only aggregate status indicators to terminal devices associated with non-clinical user role parameters.

15. The system according to claim 1, wherein the circuitry is configured to update the generative neural network model by generating training pairs from historical activity state classification labels and corresponding validated anomaly outcome records, and fine-tune the model to improve anomaly detection accuracy for specific activity pattern and physiological parameter combinations.

16. The system according to claim 1, wherein the circuitry is configured to issue the emergency contact command by generating a structured emergency notification data record comprising the monitored entity identifier, the anomaly type, the current timestamp, and a location identifier, and transmitting the emergency notification data record to an emergency response service endpoint via the communication interface.

17. The system according to claim 1, wherein the imaging devices are distributed across areas of a monitoring facility, the wearable monitoring devices are worn by the monitored entity, the edge server applies privacy masking prior to cloud transmission, and the anomaly determination record identifies safety-relevant events in the monitored environment.

18. A system comprising:
circuitry configured to:
receive, via a communication interface coupled to a packet-switched network, video stream data from imaging devices and physiological parameter data from wearable monitoring devices, and apply real-time privacy masking at an edge server to generate a silhouette data stream;
apply a pose estimation model to skeletal joint coordinates from the silhouette data stream, apply a biosensor analysis model to physiological parameter time-series, and apply a multivariate anomaly detection model to combined motion and physiological features;
generate an anomaly determination record when a joint anomaly probability score exceeds a threshold, and apply a generative neural network model to generate a recommended care action sequence from historical resolution records; and
transmit alert notifications to terminal devices and issue emergency contact commands to emergency response service endpoints when anomaly severity exceeds an emergency threshold.

19. The system according to claim 18, wherein the circuitry is configured to apply a fall detection model to rapid vertical joint coordinate displacement events, detect prolonged inactivity events from position tracking data, apply a longitudinal monitoring model to detect gradual state deterioration trends, and generate periodic monitoring summary reports from accumulated monitoring records.

20. A method comprising:
receiving, via a communication interface coupled to a packet-switched network, video stream data from imaging devices and physiological parameter data from wearable monitoring devices, and applying real-time privacy masking at an edge server to generate a silhouette data stream while discarding original image data;
applying a generative neural network model to the silhouette data stream to generate activity state classification labels, and applying a biosensor analysis model to the physiological parameter data to compute physiological deviation scores;
applying an integrated anomaly detection model to generate an anomaly determination record when an anomaly threshold is exceeded; and
transmitting the anomaly determination record and alert notifications to terminal devices via the communication interface, and issuing an emergency contact command when an anomaly severity score exceeds an emergency threshold.
